(19) United States
(12) Patent Application Publication
(10) Pub. No.: US 2004/0264488 A1
(43) Pub. Date: Dec. 30, 2004

(54) Apparatus and method for processing packets

(76) Inventors: Hyun-Min Yoon, Suwon-si (KR); Seong-Joon Jeon, Yongin-si (KR); Myeon-Kee Youn, Incheon-si (KR)

Correspondence Address: Robert E. Bushnell, Suite 300, 1522 "K" Street, N.W., Washington, DC, 20005-1202, US

(21) Appl. No.: 10/874,341

(22) Filed: Jun. 24, 2004

(30) Foreign Application Priority Data
Jun. 25, 2003 (KR) 2003-41750
Jun. 10, 2004 (KR) 2004-42758

(51) Int. Cl. H04L 12/56

(52) U.S. Cl. 370/412

(57) ABSTRACT

An apparatus and method for processing packets makes use of a double queue, manages medium access control(MAC) addresses of real-time service terminals through a link list, and assigns a priority to real-time service packets, so that when packet service is provided, the real-time service packets are processed in preference, and then when the real-time service packets are completely processed, data packets are processed. Thus, it is possible to guarantee the Quality of Service(QoS) of voice or moving image packets. In addition, when the real-time service packets are only the voice packets, a fragmentation threshold value is provided to the data terminals from which the data packets are transmitted, and when the data packets transmitted from the data terminals are processed, the maximum permissible delay time of the voice packets is calculated, and then each data packet is inserted between the voice packets. Thereby, it is possible to enhance throughput for traffic of each data terminal.

### CLAIM OF PRIORITY

This application makes reference to, incorporates the same herein, and claims all benefits accruing under 35 U.S.C. §119 from applications for WLAN DEVICE DRIVER FOR QoS SUPPORTING AND TRAFFIC QUEUING METHOD USING IT earlier filed in the Korean Intellectual Property Office on 25 Jun. 2003 and there duly assigned Ser. No. 2003-41750, and for APPARA TUSAND METHOD FOR PROCESSING PACKETS earlier filed in the Korean Intellectual. Property Office on 10 Jun. 2004 and there duly assigned Serial No. 2004-42758.

### BACKGROUND OF THE INVENTION

1. Field of the Invention

The present invention relates to an apparatus and method for processing packets. More particularly, the present invention is directed to an apparatus and method for processing packets, in which a multiple queue model for sorting and processing real-time service packets (image/voice packets) and data packets is provided and simultaneously fragmentation threshold values of the data packets are dynamically adjusted, thereby efficiently and continuously providing real-time service (image/voice service).

2. Description of the Related Art

With advancement in industrial societies, a volume of information is extremely increased day by day. Hence, demands of users who intend to rapidly and accurately use massive information are also rapidly increased.

Therefore, in order to rapidly and accurately transceive these massive information, there is an essential need for high-speed data transmission technology. Further, recently, due to development of circuit and component technologies, availability of frequency bands without permission, popularization of portable computers and so forth, a growing interest is taken in the wireless local area network(WLAN) capable of not only guaranteeing a certain degree of mobility but also transmitting data at a high speed, and thus products for the WLAN are developed and distributed by their manufacturers.

In the initial stage of development of the WLAN, there was no standard architecture. However, there has, recently, been in the process of preparing standardization based on the architecture recommended by IEEE (Institute of Electrical and Electronics Engineers) 802.11 Committee, as one of standardization tasks of the WLAN.

In addition, with development of Internet, integrated telephone processing can be realized by application of an existing Internet Protocol (IP) network as it stands. Thereby, a wide use has been made of voice over IP (VoIP) services, which are adapted to allow telephone users to make a long-distance call as well as an international call under the environment of Ethernet only at a local call rate.

Therefore, IP networks have been converted into a structure to guarantee a quality of VoIP service. Conventionally, the IP networks have been established for efficient transmission of text-oriented data, and require a quality of service (QoS) only within a range of preventing data from being damaged or lost. However, because of advancement in IP network technologies, it is possible to transmit voice data over the IP network in a real time. For this reason, technologies capable of guaranteeing the quality of VoIP service are increasingly playing an important role.

Thus, the WLAN system using the IP network has a tendency that the importance of QoS is gradually increased so as to process normal data as well as audio/video data and simultaneously to process the audio/video data at a high quality level.

Hereinafter, the WLAN complying with the IEEE 802.11 standard will be described with reference to the attached drawings.

FIG. 1 schematically shows a network connection of the general WLAN.

As shown in FIG. 1, the WLAN is composed of an access point (AP) connected with an internal protocol (IP) network by wire or cable, and WLAN service terminals 2a to 2e connected with the AP 1 by wireless.

Each of the WLAN service terminals 2a to 2e refers to a device having two kinds of interfaces, MAC interface and physical layer interface, suitable for a wireless medium in order to perform communication with the AP 1 connected over the WLAN. To perform communication, each WLAN service terminal is generally equipped with a network interface card (NIC) for the WLAN to thus perform transmission/reception of data.

When data is generated, these WLAN service terminals 2a to 2e modulate the data into an analog signal and then to transmit the analog signal through a wireless channel. According to a kind of the data processed by the WLAN service terminals 2a to 2e, the WLAN service terminals 2a to 2e can be sorted into VoIP terminals 2a and 2b for voice data, data terminals 2c and 2d for normal data and a real-time service terminal 2e for real-time dynamic image/voice. Here, the VoIP terminals 2a and 2b may be sorted into the real-time service terminal.

The AP 1 is a system having two kinds of interfaces, MAC interface and physical layer interface, suitable for a wireless medium like the WLAN service terminals 2a to 2e, and supports the WLAN service terminals 2a to 2e so that they can be connected to the IP network. To this end, the AP 1 interprets analog signals from the WLAN service terminals 2a to 2e into digital signals. Each of the interpreted digital signals becomes a 802.11 frame packet, or WLAN packet, which is settled as a standard in the wireless Internet.

When transmitted to the IP network connected with the AP 1 by wire, the 802.11 packet is converted into a 802.3 frame/packet as another Internet frame/packet, and then used as the frame/packet for TCP (Transmission Control Protocol), UDP (User Datagram Protocol) or so forth. The foregoing is associated with reception operation of the WLAN service terminals 2a to 2e and the AP 1. However, it will be apparent to those skilled in the art that transmission operation can be performed through signal paths reverse to the reception operation, and thus its description will be omitted.

FIG. 2 is a detailed block diagram showing a configuration of the AP 1 shown in FIG. 1.

As shown in FIG. 2, the AP 1 is composed of an NIC 10 for performing an external interface with the WLAN service terminals 2a to 2e, a WLAN device driver 20 for performing an internal interface between the NIC 10 and a protocol stack 30, and the protocol stack 30 for processing transceived packets according to a communication protocol.

The NIC 10 includes a wireless transceiver 12 supporting operation of a first layer and a MAC processor 11 supporting operation of a second layer.

When analog signals are received from the WLAN service terminals 2a to 2e through a wireless medium, the wireless transceiver 12 of the NIC 10 receives the analog signals, and then provides the received analog signals to the MAC processor 11. The MAC processor 11 demodulates the analog signals provided from the wireless transceiver 12 to generate 802.11 packets, and then transmits the generated 802.11 packets to the WLAN device driver 20.

Further, when receiving the 802.11 packets from the WLAN device driver 20, the MAC processor 11 demodulates the received 802.11 packets to convert it into analog signals, and transmits the converted analog signals to the wireless transceiver 12. Then, the wireless transceiver 12 transmits the analog signals, which are transmitted from the MAC processor 11, to the WLAN service terminals 2a to 2e through the wireless medium.

The WLAN device driver 20 functions as the internal interface which processes the packets received from the NIC 10 to transmit it to the protocol stack 30 using a receive queue 22, and transmits the packets received from the protocol stack 30 to the NIC 10 using a transmit queue 21.

To this end, the WLAN device driver 20 is provided with the transmission and reception queues 21 and 22. Thus, when a new 802.11 packet is generated, the WLAN device driver 20 stores the generated the 802.11 packet in the transmission queue 21, and then processes the stored 802.11 packet according to a FIFO (first in first out) discipline to transmit it to the protocol stack 30.

Further, the WLAN device driver 20 stores a 802.3 packet transmitted from the protocol stack 30 in the reception queue 21, and then processes the stored 802.3 packet according to the FIFO discipline as in the transmission queue 21 to transmit it to the NIC 10.

The protocol stack 30 is core software realizing a protocol for communication between respective communication instruments. The 802.3 packet inputted from the WLAN device driver 20 is packed to the network protocol through encoding, wrapping and framing by the protocol stack 30. The packed packet is transmitted to a client through the IP network.

Further, the protocol stack 30 converts the packet received through the IP network into an available packet through a series of procedures such as separating an address from the received packet, unwrapping, decoding and so forth, and transmits the converted packet to the WLAN device driver 20 again.

In this manner, the conventional WLAN device driver 20 has the transmission and reception queues 21 and 22, so that the WLAN device driver 20 stores the frame packets in the corresponding queue according to a sequence in which the frame packets are transmitted or received, and then processes the stored frame packets according to the FIFO discipline. 100271 This means that the frame packets such as the data packets and the real-time service packets (moving image/voice packets) are processed without discrimination and that the frame packets can be used without any trouble if only the data terminals 2c and 2d for transceiving normal. data are connected to the AP 1.

However, when several kinds of terminals, such as the data terminals 2c and 2d, the VoIP terminals 2a and 2b as voice dedicated terminals, and the real-time service dedicated terminal 2e, are simultaneously connected to the AP 1, the real-time service packets (image/voice packets) and the normal data packets are processed en bloc with the identical priority in the transmit or receive queue 21 or 22. As a result, there occurs a problem in that voice call and moving image service are rapidly deteriorated in quality.

In addition, the voice packet provided to the VoIP terminals has a slightly different size according to a size of its payload, but a small size of 20 byte or so. By contrast, the data packet has a relatively large size. Hence, when the voice packet and the data packet are present together, a transmission delay of the voice packet is generated by that of the data packet.

Therefore, the voice packet is lowered in transmission efficiency. As a result, when the. voice packet fails to be transmitted to its destination within the maximum delay time, the voice call is disconnected by the nature of the voice packet as an inevitable consequence. This results in another problem in that it is difficult to guarantee the QoS of the VoIP service.

### SUMMARY OF THE INVENTION

It is, therefore, an object of the present invention to provide an apparatus and method for processing packets to guarantee efficient and continuous service while real-time service packets such as voice and image packets are transmitted and received by using a double queue considering a priority between the real-time service packets and general data packets in order to guarantee a QoS of the packet of real-time service terminals (e.g., VOIP terminal, real-time packet service terminal as an image service terminal, etc.) during processing the packets.

It is another object of the present invention to provide an apparatus and method for processing packets, in which when the real-time service packets are only the voice packets, a fragmentation threshold value is provided to the data terminals from which the data packets are transmitted, and when the data packets transmitted from the data terminals are processed, the maximum permissible delay time of the voice packets is calculated, and then each data packet is inserted between the voice packets, thereby enhancing throughput for traffic of each data terminal.

To achieve the above and other objects, according to one aspect of an apparatus for processing packets according to the present invention, the apparatus includes a reception queue, including a first reception queue processing at least one real-time service packet (image/voice packet) and a second reception queue processing at least one data packet, for processing at least one of the real-time service packet and data packets received from at least one service terminal and for transmitting the processed packet to an Internet protocol (IP) network; a transmission queue, including a first transmission queue processing at least one real-time service packet and a second transmission queue processing at least one data packet, for processing at least one of the real-time service and data packets received from the IP network and for transmitting the processed packet to the at least one service terminal; and a packet processor for controlling transmission of the real-time service and data packets stored in the reception and transmission queues to any one of the IP network and the service terminal in accordance with a preset priority.

The service terminal includes at least one of: at least one real-time service terminal for processing the real-time service packet to provide real-time voice and image services; and at least one data terminal for processing the data packet to provide data communication service.

Further, the apparatus further includes a pre-processing controller for setting a priority to process at least one of transmitted/received packets according to kinds of the transmitted/received packets; and a storage unit for storing information on the priority to compare and analyze kinds of the transmitted/received packets. Here, the priority information includes information on a medium access control (MAC) address of the real-time service terminal.

The packet processor compares the MAC addresses of the real-time service terminals stored in the storage unit with a source address of any one of transmitted and received packets to confirm whether to be matched with the source address, determines any one of transmitted and received packets to be the real-time service packet when the matched MAC address exists in the storage unit, and stores the result in any one of the first transmission and reception queues, and determines any one of transmitted and received packets to be the data packet when the matched MAC address does not exist in the storage unit and stores the result in any one of the second transmission and reception queues.

Preferably, the packet processor includes: a reception controller for preferentially processing the real-time service packet stored in the first reception queue, transmitting the processed packet to the IP network, and when the real-time service packets are all transmitted, transmitting the data packet stored in the second reception queue to the IP network; and a transmission controller for preferentially processing the real-time service packet stored in the first transmission queue, transmitting the processed packet to the IP network, and when the real-time service packets are all transmitted, transmitting the data packet stored in the second transmission queue to the service terminal.

The reception controller is holding transmission of the data packet when at least one new real-time service packet is coming in the first reception queue while the data packet stored in the second reception queue is processed and transmitted to the IP network, and after the new real-time service packets coming in the first reception queue are all transmitted to the IP network, transmitting the held data packet to the IP network.

The transmission controller is holding transmission of the data packet when at least one new real-time service packet is coming in the first transmission queue while the data packet stored in the second transmission queue is processed and transmitted to a data terminal of the service terminals, and after the new real-time service packets coming in the first transmission queue are all transmitted to the service terminals, transmitting the held data packet to a real-time service terminal of the service terminals.

When the real-time service packet is a voice packet, a fragmentation threshold value is calculated using an average permissible transmission delay time of the voice packet and the number of voice over Internet protocol (VoIP) and data terminals of the service terminals connected to a system and provides the result to the data terminal.

The packet processor controls the reception queue such that, when a voice packet is received from a VoIP terminal of the service terminals, the received voice packet is preferentially processed and that the data packet transmitted from a data terminal of the service terminals is processed within an average permissible transmission delay time of the voice packet; and processes the voice packet to be transmitted to the VoIP terminal in preference and then the data packet to be transmitted to the data terminal within the average permissible transmission delay time of the voice packet.

The average permissible transmission delay time of the voice packet in the pre-processing controller is calculated using at least one of: a) the number of the VoIP terminals connected to the system, b) the number of the data terminals connected to the system, c) a first time which it takes the VoIP terminal to successfully complete transmission of one voice packet after acquisition of a channel, d) a first lapse time consumed until the VoIP terminal fails to transmit the voice packet, e) a second time which it takes the data terminal to successfully complete transmission of one data packet after acquisition of a channel, f) a second lapse time consumed until the data terminal fails to transmit the data packet, g) a first probability of packet transmission by any one of the VoIP terminal and the data terminal, h) a second probability of packet transmission failure by any one of the VoIP terminal and the data terminal, i) a first average payload size of data packets, j) a second average payload size of voice packets, k) the maximum number of backoff stages, and l) a data transmission rate of the system.

According to one aspect of a method for processing packets according to the present invention, the method includes a) when any one of at least one real-time service packet (image/voice packet) and at least one data packet is received from an Internet protocol (IP) network, storing the received packets in different transmission queues respectively based on the kinds of the received. packets; and b) processing the real-time service packets stored in the transmission queues in preference, transmitting the processed real-time service packets to at least one real-time service terminal, processing the data packets stored in the transmission queues after transmission of the real-time service packets is completed, and transmitting the processed data packets to at least one data terminal.

The step a) includes comparing previously stored MAC addresses of the real-time service terminals with a source address of a packet received from the IP network to confirm whether to be matched with the source address, determining the received packet to be the real-time service packet when the matched MAC address is present, and storing the result in a real-time service packet transmission queue of the transmission queues, determining the received packet to be the data packet when the matched MAC address is not present, and storing the result in a data transmission queue of the transmission queues.

The step b) includes holding transmission of the data packet when at least one new real-time service packet is coming in a real-time service packet transmission queue of the transmission queues while the data packet stored in a data transmission queue of the transmission queues is processed and transmitted to the data terminal, and after the new real-time service packets coming in the real-time service packet transmission queue are all transmitted to the real-time service terminal, transmitting the held data packet to the data terminal.

The method further includes c) when any one of the real-time service packet (image/voice packet) and the data packet is received from any one of the real-time service terminal and the data terminal, storing the received packets in different reception queues respectively based on the kinds of the received packets; and d) processing the real-time service packets stored in the reception queues in preference, transmitting the processed real-time service packets to the IP network, processing the data packets stored in the reception queues after transmission of the real-time service packets is completed, and transmitting the processed data packets to the IP network.

The step c) includes comparing previously stored MAC addresses of the real-time service terminals with a source address of a packet received from any one of the real-time service terminal and the data terminal to confirm whether to be matched with the source address, determining the received packet to be the real-time service packet when the matched MAC address is present, and storing the result in a real-time service packet reception queue of the reception queues, determining the received packet to be the data packet when the matched MAC address is not present, and storing the result in a data reception queue of the reception queues.

The step d) includes holding transmission of the data packet when at least one new real-time service packet is coming in a real-time service packet reception queue of the reception queues while the data packet stored in a data reception queue of the reception queues is processed and transmitted to the IP network, and after the new real-time service packets coming in the real-time service packet reception queue are all transmitted to the IP network, transmitting the held data packet to the IP network.

According to another aspect of an apparatus for processing packets according to the present invention, the apparatus includes: a reception queue for sequentially storing any one of at least one real-time service packet and at least one data packet which are received from at least one service terminal; a transmission queue for storing at least one real-time service packet and at least one data packet which are received from an Internet protocol (IP) network in different queues respectively; and a transmission/reception controller for controlling transmission of the real-time service and data packets stored in the transmission queue to the IP network in accordance with a preset priority and transmission of the packets stored in the reception queue through a sequential processing operation.

The transmission/reception controller includes: a transmission controller for sequentially processing any one of the real-time service and data packets stored in the reception queue according to a first in first out (FIFO) discipline and for transmitting the processed result to the IP network; and a reception controller for preferentially processing the real-time service packet stored in a real-time service packet transmission queue of the transmission queue, transmitting the processed result to a real-time service terminal of the service terminals, and when the real-time service packets are all transmitted, transmitting the data packet stored in a data transmission queue of the transmission queue to a data terminal of the service terminal.

According to another aspect of a method for processing packets according to the present invention, the method includes: a) when any one of at least one real-time service packet (image/voice packet) and at least one data packet is received from an Internet protocol (IP) network, storing the received packets in a real-time service packet transmission queue and a data transmission queue respectively based on the kinds of the received packets, and sequentially storing any one of at least one real-time service packet and at least one data packet which are received from at least one service terminal in a reception queue; and b) b-1) processing the real-time service packets stored in the real-time service packet transmission queue in preference, transmitting the processed real-time service packets to at least one real-time service terminal, processing the data packets stored in the data transmission queue after transmission of the real-time service packets is completed, and transmitting the processed data packets to at least one data terminal, and b-2) sequentially transmitting at least one of the real-time service packets and the data packets which are sequentially stored in the reception queue to the IP network.

According to yet another aspect of an apparatus for processing packets according to the present invention, the apparatus includes: a pre-processing controller for calculating a fragmentation threshold value and for providing the calculated fragmentation threshold value to at least one service terminal; a reception queue, including a voice reception queue processing at least one voice packet and a data reception queue processing at least one data packet, for processing at least one packet received from the service terminal and for transmitting the processed packet to an Internet protocol (IP) network; a transmission queue, including a voice transmission queue processing at least one voice packet and a data transmission queue processing at least one data packet, for processing at least one packet received from the IP network and for transmitting the processed packet to the service terminal; and a transmission/reception controller for controlling transmission of the real-time service and data packets stored in the reception and transmission queues to any one of the IP network and the service terminal in accordance with a preset priority.

The service terminal includes at least one of: at least one voice over Internet protocol (VoIP) terminal for processing the voice packet to provide voice service; and at least one data terminal for processing the data packet to provide data communication service.

The transmission/reception controller includes: a reception controller for controlling the reception queue so that the voice packet transmitted from a VoIP terminal of the service terminals is is preferentially processed and that the data packet transmitted from a data terminal of the service terminals within an average permissible transmission delay time of the voice packet; and a transmission controller for controlling the transmission queue such that the voice packet to be transmitted to the VoIP terminal is preferentially processed and that the data packet to be transmitted to the data terminal within the average permissible transmission delay time of the voice packet.

The pre-processing controller calculates the fragmentation threshold value using the average permissible transmission delay time of the voice packet and the number of VoIP and data. terminals of the service terminals when the number of the VoIP terminals is changed.

According to yet another aspect of a method for processing packets according to the present invention, the method includes: a) when the number of voice over Internet protocol (VoIP) terminals is changed, calculating a fragmentation threshold value and transmitting the calculated fragmentation threshold value to at least one data terminal connected to a system; b) when any one of at least one voice packet and at least one data packet is received from any one of the VoIP terminal and the data terminal, storing the received packet in a corresponding queue according to a kind of the received packet; and c) processing the voice packet stored in the queue in preference, transmitting the processed voice packet to the IP network, processing the data packet within an average permissible transmission delay time (X), and transmitting the processed data packet to the IP network.

The step b) includes storing the voice packet in a voice reception queue of the queue when the received packet is the voice packet, and storing the data packet in a data reception queue of the queue when the received packet is the data packet.

The step a) includes: detecting whether the number of the VoIP terminals connected to the system is changed or not; calculating the average permissible transmission delay time (X) when the number of the VoIP terminals is changed; and calculating the fragmentation threshold value using the calculated average permissible transmission delay time and the number of VoIP and data terminals connected to the system and transmitting the calculated fragmentation threshold value to the data terminal.

The step c) further includes: checking whether the voice packet exists in a corresponding reception queue of the queue within the average permissible transmission delay time; and as a result of the checking, when the voice packet exists in the corresponding reception queue within the average permissible transmission delay time, processing the data packet and transmitting the processed data packet to the IP network.

The method further includes: d) when the data packets or the voice packets are received from the IP network, storing the received packets in different transmission queues respectively based on the kinds of the received packets; and e) processing the voice packets stored in the transmission queues in preference, transmitting the processed voice packets to the VoIP terminals, processing the data packets within the average permissible transmission delay time, and transmitting the processed data packets to the data terminals.

The step e) further includes: checking whether the voice packet to be processed within the average permissible transmission delay time exists in the transmission queue; and as a result of the checking, when the voice packet to be processed within the average permissible transmission delay time does not exist, processing the data packets and transmitting the processed data packets to the data terminals.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings, in which like reference symbols indicate the same or similar components, wherein:

FIG. 1 schematically shows a network connection of the general WLAN system;

FIG. 2 is an internal block diagram showing a configuration of the AP 1 shown in FIG. 1;

FIG. 3 is an internal block diagram of an apparatus for processing packets according to an exemplary embodiment of the present invention;

FIG. 4 shows a MAC address management structure of a link list according to the present invention;

FIG. 5 shows a structure of a real-time service packet according to the present invention;

FIGS. 6a and 6b show operational flow charts showing a method of processing packets according to an exemplary embodiment of the present invention;

FIG. 7 is an operational flow chart showing a method of calculating the fragmentation threshold value to serve voice and data packets of real-time service packets as one embodiment of the present invention;

FIGS. 8a and 8b are operational flow charts showing a method for processing voice and data packets of transceived real-time service packets as one embodiment of the present invention; and

FIG. 9. shows an example of a computer including a computer-readable medium having computer-executable instructions for performing a technique of the present invention.

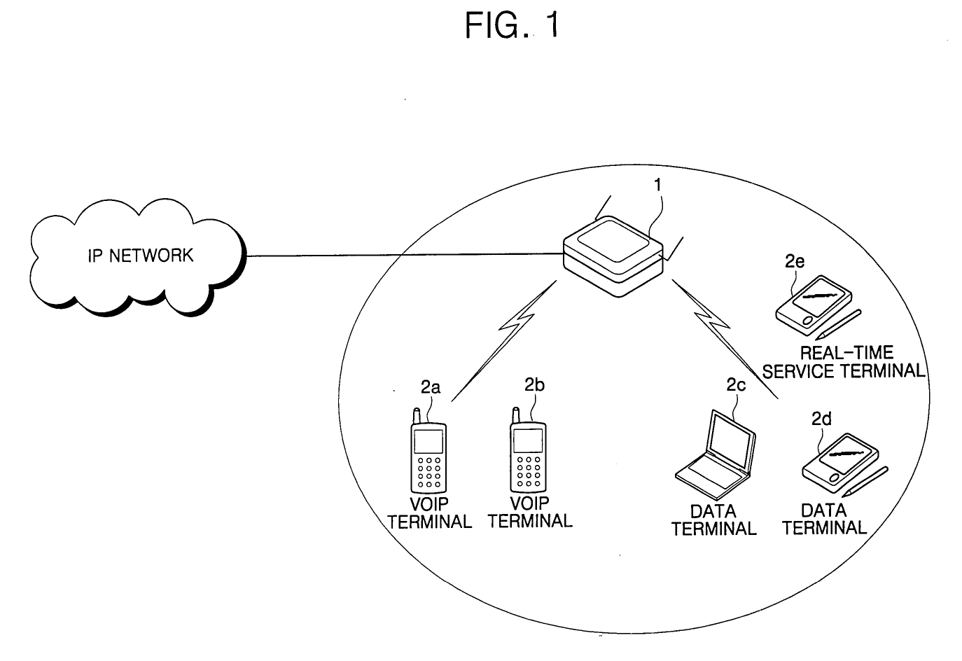

### DETAILED DESCRIPTION OF THE INVENTION

The present invention will now be described more fully hereinafter with reference to the accompanying drawings, in which exemplary embodiments of the invention are shown. The exemplary embodiments of the invention will be described taking an access point (AP) of a wireless local area network (WLAN) as one example, but it will be understood to those skilled in the art that the apparatus and method for processing packets of the present invention may be applied to all the apparatuses and methods used to process packets.

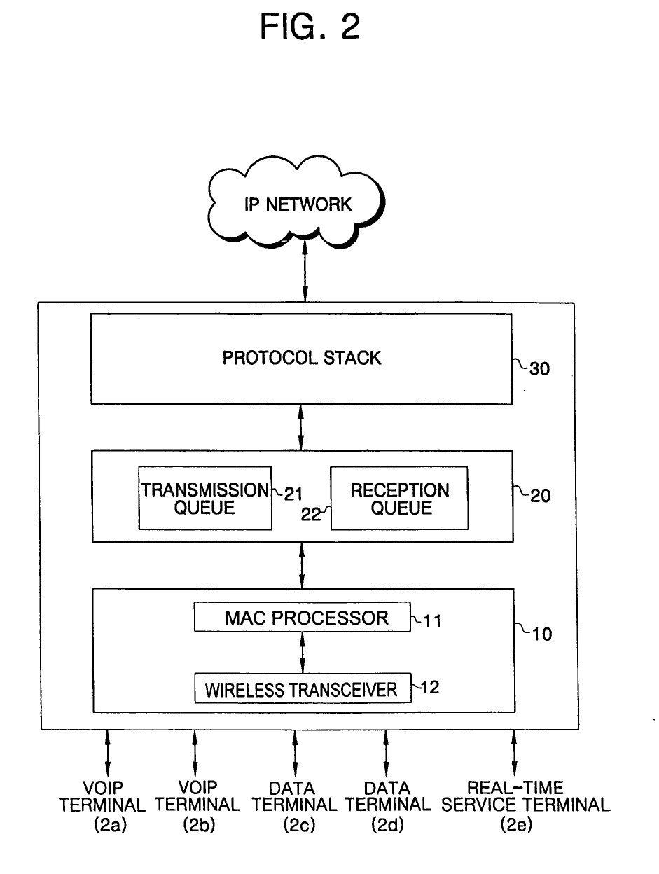

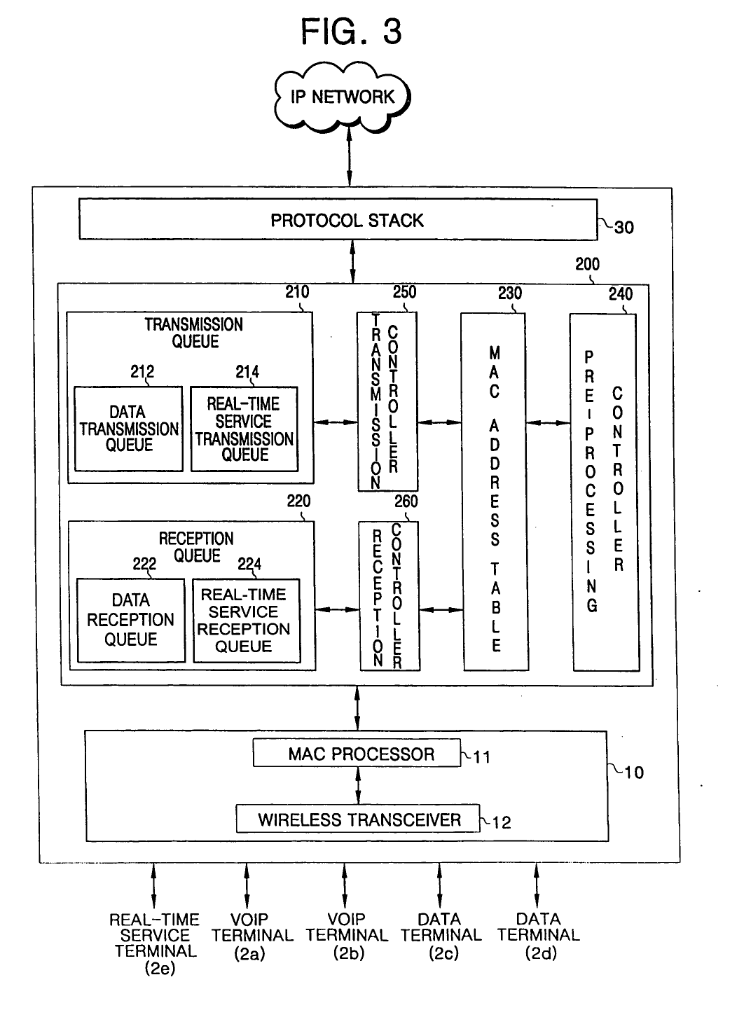

FIG. 3 is an internal block diagram of an apparatus for processing packets according to the present invention, in which the similar components overlapped with the conventional components shown in FIG. 2 will no longer be described.

As shown in FIG. 3, a wireless local area network (WVLAN) device driver 200 of the WLAN AP 1 includes a transmission queue 210, a reception queue 220, a medium access control (MAC) address table 230, a pre-processing controller 240, a transmission controller 250, and a reception controller 260.

The transmission queue 210 includes a real-time service packet transmission queue 214 for processing a real-time service packet (voice/image packet) received from the protocol stack 30, and a data transmission queue 212 for processing a data packet received from the protocol stack 30.

The reception queue 220 includes a real-time service reception queue 224 for processing a real-time service packet received from the NIC (network interface card) 10, and a data reception queue 222 for processing a data packet received from the NIC 10.

The MAC address table 230 stores MAC address information each for the WLAN service terminals 2a to 2e connected to the AP 1, and makes it possible to divide the kinds of the terminals (into real-time service terminal, VoIP terminal and data terminal) based on the MAC address information.

The pre-processing controller 240 inputs an MAC address of the real-time service terminal 2e by use of an instruction for processing the real-time service packet according to a priority, and then stores the inputted result in the MAC address table 230. Here, the real-time service terminal 2e may include the VoIP terminals 2a and 2b.

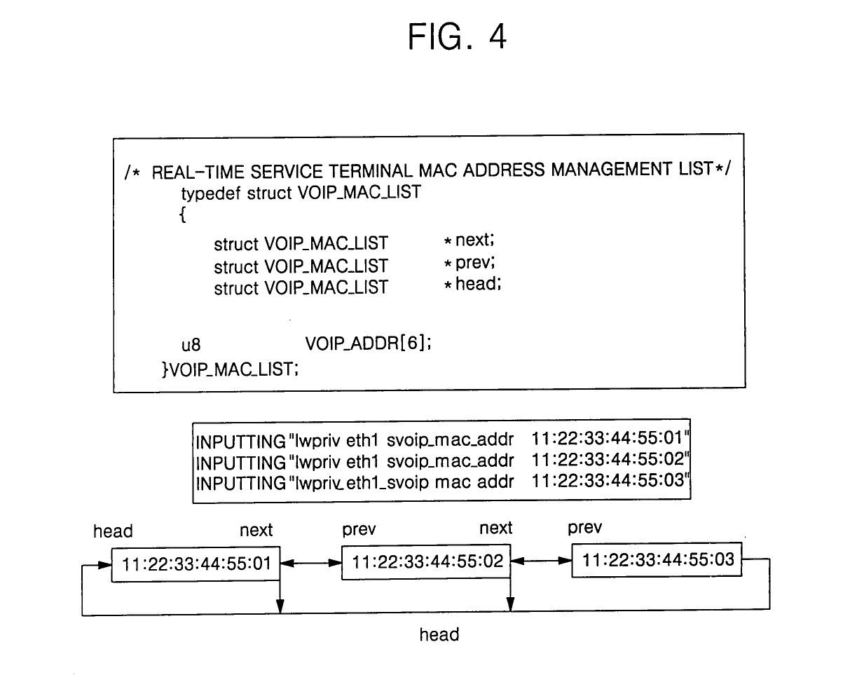

When the MAC address is inputted by the instruction for processing the real-time service packet according to the priority, a mode for double queues (data transmission/reception queue and real-time service transmission/reception queue) is adapted to be operated. As shown in FIG. 4, the instruction may make use of “iwpriv ethl svoip_mac_addr xx:xx:xx:.x:xx:xx,” where “iwpriv” is a private control instruction of the WLAN device driver 200 used in LINUX, “ethl” is an interface name of the WLAN device driver 200, “svoip_mac_addr” is a field name to be inputted, and “xx:xx:xx:xx:xx:xx” is MAC addresses of the real-time service and VoIP terminals 2e and, 2a and 2b to be actually inputted.

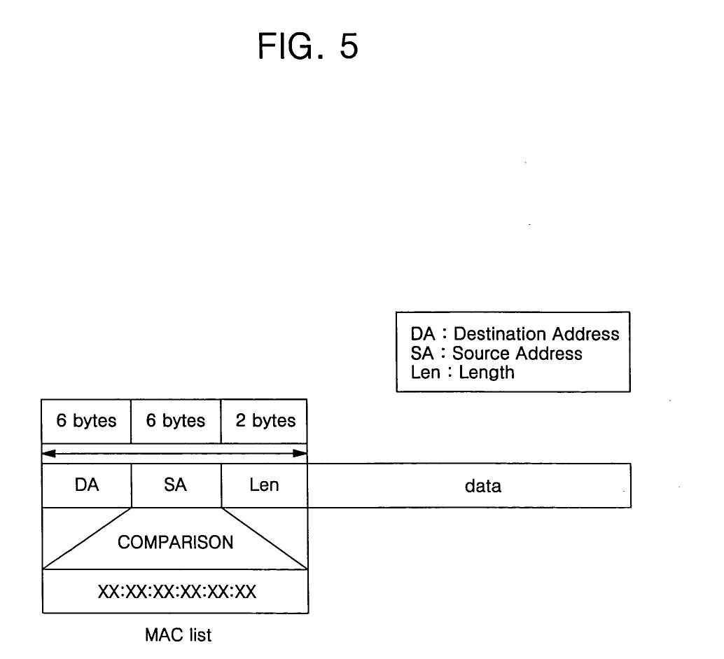

The MAC address table 230 manages the MAC addresses of the real-time service and VoIP terminals 2e and, 2a and 2b using a link list as shown in FIG. 4, and divides the kinds of the terminals connected to the AP 1 by use of the MAC addresses which are stored and managed in the MAC address table 230. In other words, when the packet is received, and when a source address within the received packet is any one of the MAC addresses existing in the MAC address table 230, the received packet is determined to be the real-time service packet (image/voice packet) for transmission to the real-time service terminal 2e or the VoIP terminals 2a and 2b. Here, FIG. 4 shows a MAC address management structure of a link list according to the present invention, and FIG. 5 shows a structure of a real-time service packet according to the present invention.

When a packet is received from the protocol stack 30 of the AP 1, the transmission controller 250 shown in FIG. 3 confirms a source address of the received packet, and then compares the source address with any one of the MAC addresses of the real-time service terminals which is stored in the MAC address table 230.

As a result of the comparison, if the MAC address of the real-time service terminal 2e or the VoIP terminal 2a or 2b, which is matched with the source address of the packet received from the protocol stack 30, exists in the MAC address table 230, the transmission controller 250 determines the received packet to be the real-time service packet, and stores the received packet in the real-time service packet transmission queue 214.

However, when the MAC address of the real-time service terminal 2e or the VoIP terminal 2a or 2b, which is matched with the source address of the packet received from the protocol stack 30, does not exist in the MAC address table 230, the transmission controller 250 determines the received packet to be the data packet, and stores the received packet in the data transmission queue 212.

Further, the transmission controller 250 controls the real-time service packet transmission queue 214 so as to preferentially process the real-time service packet, and checks a flag to confirm whether the real-time service packet intended for transmission exists in the real-time service packet transmission queue 214 or not.

As a result of checking the flag of the real-time service packet transmission queue 214, if the real-time service packet to be processed does not exist, the flag of the real-time service packet transmission queue 214 is reset, and then transmission of the data packet existing in the data transmission queue 212 is controlled.

The reception controller 260 confirms a source address of a packet received from the NIC 10 and compares the source address with any one of the MAC addresses of the MAC address table 230.

As a result of the comparison, if the MAC address of the real-time service terminal 2e or the VoIP terminal 2a or 2b, which is matched with the source address of the packet received from the NIC 10, exists in the MAC address table 230, the reception controller 260 determines the received packet to be the real-time service packet, and stores the received packet in the real-time service reception queue 224 after removing a 802.11 header from the real-time service packet.

By the contrary, if the MAC address of the real-time service terminal 2e or the VoIP terminal 2a or 2b, which is matched with the source address of the packet received from the NIC 10, does not exist in the MAC address table 230, the reception controller 260 determines the received packet to be the data packet, and stores the received packet in the data reception queue 222 after removing a 802.11 header from the data packet.

Further, the reception controller 260 controls the real-time service reception queue 224 so as to preferentially process the real-time service packet, and checks a flag to confirm whether the real-time service packet to be processed exists in the real-time reception queue 224 or not.

As a result of checking the flag of the real-time service reception queue 224, if the real-time service packet to be processed does not exist, the flag of the real-time service reception queue 224 is reset, and then processing the data packet existing in the data reception queue 224 is controlled.

The following description will be made regarding an operation of the apparatus for processing packets in the AP according to the present invention, which is configured as set forth above.

To begin with, when a packet is received from the protocol stack 30 shown in FIG. 3, the transmission controller 250 of the WLAN device driver 200 confirms a source address of the received packet, and compares whether the confirmed source address is matched with the MAC address of the real-time service terminal 2e or the VoIP terminal 2a or 2b which is stored in the MAC address table 230.

As a result of the comparison, the transmission controller 250, if the MAC address of the real-time service terminal 2e or the VoIP terminal 2a or 2b, which is matched with the source address of the packet received from the protocol stack 30, exists in the MAC address table 230, the transmission controller 250 determines the received packet to be the real-time service packet, and stores the received packet in the real-time service packet transmission queue 214.

However, if the MAC address of the real-time service terminal 2e or the VoIP terminal 2a or 2b, which is matched with the source address of the packet received from the protocol stack 30, does not exist in the MAC address table 230, the transmission controller 250 determines the received packet to be the data packet, and stores the received packet in the data transmission queue 212.

Subsequently, the reception controller 260 checks a flag to confirm whether the real-time service packet to be processed exists in the real-time service packet transmission queue 214 or not. If the real-time service packet to be processed exists in the real-time service packet transmission queue 214, the corresponding real-time service packet is transmitted to the real-time service terminal 2e which corresponds to its destination address through the NIC 10.

In this manner, when transmission of the whole real-time service packets stored in the real-time service packet transmission queue 214 is completed, the transmission controller 250 determines whether a data packet exists in the data transmission queue 212 or not. If the data packet to be processed exists in the data transmission queue 212, the data packet is transmitted to the corresponding data terminals 2c and 2d which correspond to its destination address through the NIC 10.

Here, the transmission controller 250 checks a flag to confirm whether the real-time service packet to be transmitted to the real-time service packet transmission queue 214 exists whenever the data packet stored in the data transmission queue 212 is transmitted.

When a new real-time service packet is coming in the real-time service packet transmission queue 214 during the transmission of the data packet, a transmission service of the real-time service packet stored in the real-time service packet transmission queue 214 is performed after a transmission service of the data packet is blocked.

By the contrary, when a packet is received from the NIC 10, the reception controller 260 confirms a source address of the received packet, and compares whether the confirmed source address is matched with the MAC address of the real-time service terminal 2e or the VoIP terminal 2a or 2b which is stored in the MAC address table 230.

As a result of the comparison, if the MAC address of the real-time service terminal 2e or the VoIP terminal 2a or 2b, which is matched with the source address of the packet received from the NIC 10, exists in the MAC address table 230, the reception controller 260 determines the received packet to be the real-time service packet, and stores the received packet in the real-time service reception queue 224.

However, if the source address of the packet received from the NIC 10 is not matched with the MAC address of the real-time service terminal 2e or the VoIP terminal 2a or 2b, the reception controller 260 determines the received packet to be the data packet, and stores the received packet in the data reception queue 222.

Subsequently, the reception controller 260 checks a flag of the real-time service packet to confirm whether the real-time service packet exists in the real-time service reception queue 224 or not. If the real-time service packet to be processed exists, the corresponding real-time service packet is transmitted to the IP network through the protocol stack 30.

In this manner, when transmission of the whole real-time service packets stored in the real-time service reception queue 224 is completed, the reception controller 260 determines whether a data packet exists in the data reception queue 222 or not. If the data packet to be processed exists in the data reception queue 222, the data packet is transmitted to the IP (Internet protocol) network through the protocol stack 30.

Here, the reception controller 260 checks a flag to confirm whether the real-time service packet to be transmitted to the real-time service reception queue 224 exists whenever the data packet stored in the data reception queue 222 is transmitted. When a new real-time service packet is coming in the real-time service reception queue 224 during the transmission of the data packet, a transmission service of the real-time service packet stored in the real-time service reception queue 224 is performed after a transmission service of the data packet is blocked.

The foregoing description is made about the embodiment in which the source address of the received packet/frame is checked using the reception queue 220 as the double queue (the data reception queue 222 and the real-time service reception queue 224), and which the data packet is processed after the real-time service packet is preferentially processed according to the source address. However, in another embodiment, only the transmission queue 210 is used as the double queue, while the reception queue is used as a single queue. Then, the packets received from the NIC 10 can be processed in the received order according to the FIFO discipline. In other words, since the real-time service packets are processed in the transmission queue 210 according to a priority using the transmission queue 210 as the double queue and are transmitted to the real-time service terminal 2e or the VoIP terminals 2a and 2b, the packets received from the WLAN service terminals can be sequentially processed without regard to their priority.

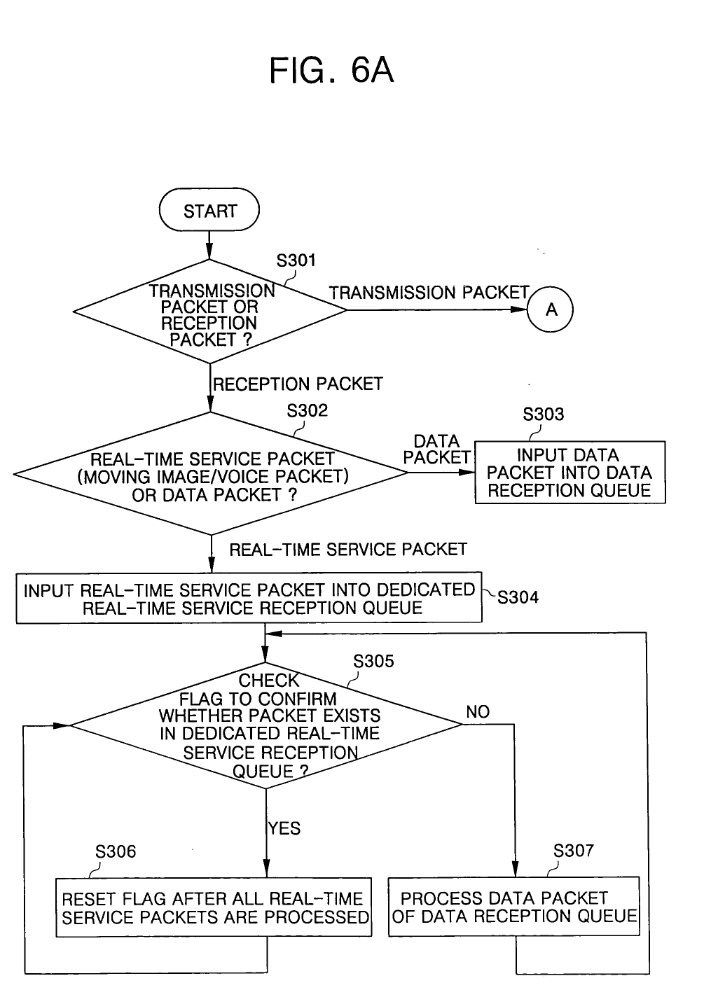

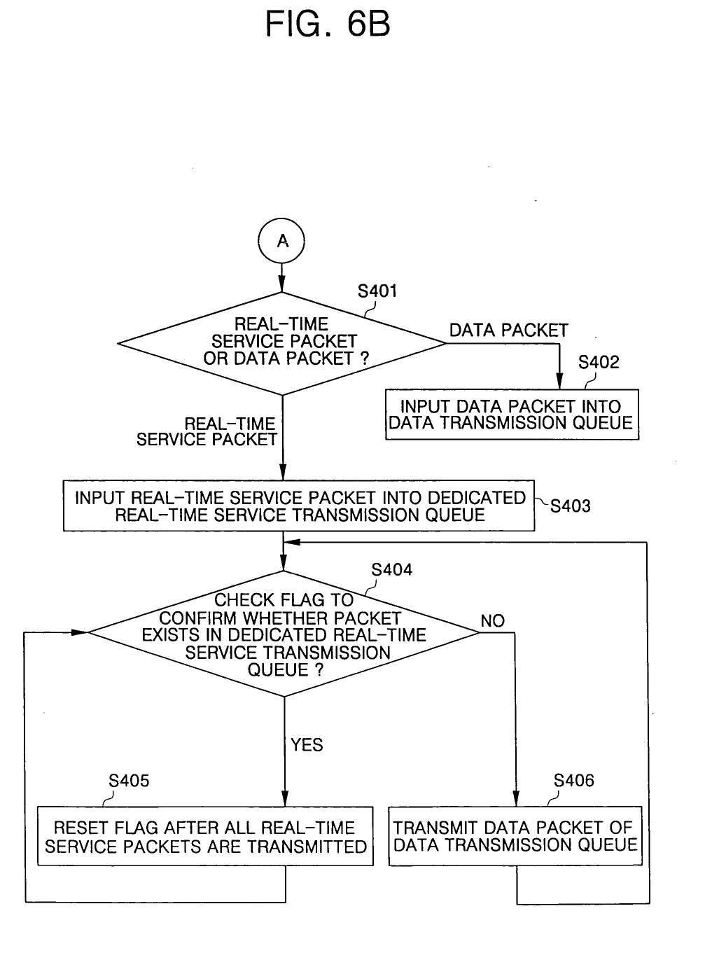

The following description will be made step by step regarding a method for processing packets in the WLAN (wireless local area network) AP (access point) according to the present invention by use of the aforementioned packet processing apparatus with reference to FIGS. 6a and 6b.

FIGS. 6a and 6b are operational flow charts of the method for processing packets in the WLAN AP according to the present invention, respectively.

First, the AP detects whether reception data or packet and transmission data or packet are coming therein, wherein the reception packet has a packet proceeding direction toward the protocol stack 30, and the transmission packet has that toward the NIC 10 (S301).

If the incoming of the reception packet is detected from the NIC 10, it is determined whether the reception packet is the real-time service packet or the data packet (S302). Here, such determination is given by use of the source address of the reception packet. Specifically, the source address of the 802.11 packet is extracted from the reception packet. The extracted source address is compared with the MAC address stored in the MAC address table to confirm whether to be matched with the MAC address. Then, it is determined whether the matched MAC address of the real-time service terminal or the VoIP terminal exists in the MAC address table or not.

As a result of the determination, if the MAC address matched with the extracted source address exists in the MAC address table, the reception packet is determined to be the real-time service packet. However, if the matched MAC address does not exist in the MAC address table, the reception packet is determined to be the data packet.

As a result of the determination in step S302, when the reception packet is the data packet, namely, when the source address of the reception packet is not matched with the MAC address within the MAC address table, the 802.11 packet is converted into the 802.3 packet by removal of the 802.11 header of the reception packet, and then the converted data packet is stored in the data. reception queue (S303).

However, in step S302, when the reception packet is the real-time service packet, namely, when the MAC address matched with the source address of the reception packet exists in the MAC address table, the reception packet is determined to be the real-time service packet, and the 802.11 packet is converted into the 802.3 packet by removal of the 802.11 header of the reception frame, and finally the converted data packet is stored in the real-time service reception queue (S304).

Subsequently, the AP checks a flag to confirm whether the real-time service packet to be processed exists in the real-time service reception queue or not (S305).

As a result of checking the flag, if the real-time service packet to be processed exists in the real-time service reception queue, the whole service packets stored in the real-time service reception queue are sequentially transmitted to the IP network through the protocol stack, and then the flag of the real-time service packet is reset (S306).

Meanwhile, when the whole real-time service packets stored in the real-time service reception queue are processed, the WLAN device driver transmits the data packets stored in the data reception queue to the IP network through the protocol stack (S307). At this point, the data packets are processed according to the FIFO discipline.

In this manner, while processing the data packets stored in the data reception queue, the WLAN device driver checks whether a new real-time service packet has come in the real-time service reception queue by checking the flag of the real-time service packet.

As a result of the checking, if the new real-time service packet has come in the real-time service reception queue, a processing operation of the data packet is blocked, and then the real-time service packet coming in the real-time service reception queue is processed.

Consequently, the real-time service packets are preferentially processed by assignment of a priority. After the real-time service packets are all transmitted, the data packets are processed. In the case that the real-time service packet is received while the data packets are processed, the processing of the data packets is stopped. After the real-time service packet is processed, the processing of the data packets is again proceeded.

Meanwhile, in the case that the incoming of the transmission packet is detected from the protocol stack in step S301 of FIG. 6a, a processing operation of the real-time service packet and the data packet will be described step by step with reference to FIG. 6b.

First, when the incoming of the transmission packet is detected from the protocol stack, it is determined whether the transmission packet is either the real-time service packet or the data packet (S401). Here, such determination is given by use of the source address of the transmission packet frame as shown in FIG. 5. To be specific, the source address of the 802.11 packet is extracted from the transmission packet. The extracted source address is compared with the MAC address stored in the MAC address table to confirm whether to be matched with the MAC address. Then, it is determined whether the matched MAC address of the real-time service terminal or the VoIP terminal exists in the MAC address table or not.

As a result of the determination, if the MAC address matched with the extracted source address exists in the MAC address table, the transmission packet is determined to be the real-time service packet. However, if the matched MAC address does not exist in the MAC address table, the transmission packet is determined to be the data packet.

In step S401, when the transmission packet coming in from the protocol stack 30 is the data packet, namely, when the source address of the transmission packet is not matched with at least one of the MAC addresses within the MAC address table, the 802.11 packet is converted into the 802.3 packet by removal of the 802.11 header of the transmission packet, and then the converted data packet is stored in the data transmission queue (S402).

However, in step S401, when the transmission packet coming in from the protocol stack is the real-time service packet, namely, when the source address of the transmission packet is matched with at least one of the MAC addresses of the real-time service terminal or the VoIP terminal which are stored in the MAC address table, the transmission packet is determined to be the real-time service packet, and the 802.11 packet is converted into the 802.3 packet by removal of the 802.11 header of the transmission packet, and finally the converted data packet is stored in the real-time service packet transmission queue (S403).

Subsequently, the AP checks a flag to confirm whether the real-time service packet to be processed exists in the real-time service packet transmission queue or not (S404).

As a result of checking the flag, if the real-time service packet to be processed exists in the real-time service packet transmission queue, the whole service packets stored in the real-time service packet transmission queue are transmitted to the corresponding real-time service terminal or the VoIP terminal through the NIC, and then the flag of the real-time service packet is reset (S405).

Meanwhile, when the whole real-time service packets stored in the real-time service packet transmission queue are processed, the WLAN device driver transmits the data packets stored in the data transmission queue to the data terminal through the NIC according to the FIFO discipline.

In this manner, while processing the data packets stored in the data transmission queue, the WLAN device driver checks whether a new real-time service packet has come in from the protocol stack by checking the flag of the real-time service packet in the real-time service packet transmission queue. If the new real-time service packet has come in the real-time service packet transmission queue, a processing operation of the data packet is blocked, and then the real-time service packet coming in the real-time service packet transmission queue is transmitted to the real-time service terminal or the VoIP terminal.

Consequently, the real-time service packets are preferentially transmitted to the real-time service terminal (including the VoIP terminal) by assignment of a priority. After the real-time service packets are all transmitted, the data packets are processed. In the case that the real-time service packet is coming in while the data packets are transmitted, the transmission of the data packets is stopped. After the real-time service packet is transmitted, the processing of the data packets is again proceeded.

In an embodiment different from the aforementioned method of processing packets in the WLAN AP according to the present invention, only the transmission queue is used as a double queue, while the reception queue is used as a single queue. Then, the packets received from the NIC can be processed in the received order according to the FIFO discipline. In other words, since the real-time service packets are processed according to a preset priority using the transmission queue as the double queue and are transmitted to the real-time service terminal, the packets received from the WLAN service terminals can be sequentially processed without regard to their priority.

In an embodiment according to the present invention, when the real-time service packet received through the protocol stack or the NIC is only the voice packet, the voice packet and the data packet are differently processed according to a priority by use of the double transmission/reception queue. The embodiment will be described with reference to FIGS. 3, 7, 8 and 9.

That is, when a served real-time service packet is the voice packet, a fragmentation threshold value is provided to the data terminals from which the data packets are transmitted. In order to process the data packets, the maximum permissible delay time of the voice packet is calculated, and then each data packet is inserted between the voice packets. Thereby, throughput for traffic of each data terminal can be enhanced.

First, the pre-processing controller 240 provides the fragmentation threshold value to the data terminals 2c and 2d connected to the AP 1 in order to support the QoS (quality of service) to a high level.

To this end, the pre-processing controller 240 dynamically calculates an average permissible delay time of the voice packet depending on change in the number of the VoIP terminals 2a and 2b connected to the AP 1. The fragmentation threshold value is calculated by use of the calculated average permissible delay time, and then provided to the data terminals 2c and 2d connected to the AP 1.

When transmitting the data packets, the data terminals 2c and 2d receiving the calculated fragmentation threshold value fragmentize the data packets to be suitable for a size of the received fragmentation threshold value. The WLAN device driver 200 receives and processes the fragmentized data packets.

A method of calculating the fragmentation threshold value will be described below in detail.

When a packet is received from the protocol stack 30, the transmission controller 250 confirms a destination address of the packet and compares the confirmed destination address with at least one MAC address in the MAC address table 230 to confirm whether to be matched with the at least one MAC address.

As a result of the comparison, when the destination address of the packet is matched with the MAC address of the VoIP terminal 2a or 2b, the received packet is determined to be the voice packet, and then the received packet is stored in the real-time service packet transmission queue 214. However, when the destination address of the packet is not matched with the MAC address of the VoIP terminal 2a or 2b, the received packet is determined to be the data packet, and then the received packet is stored in the data transmission queue 212.

The transmission controller 250 controls the real-time service packet transmission queue 214 so as to process the voice packet in preference, and controls the data transmission queue 212 so as to process the data packets within the average delay time of the voice packet.

The reception controller 260 confirms a source address of the packet received from the NIC. 10 and compares the confirmed source address with at least one MAC address in the MAC address table 230 to confirm whether to be matched with the at least one MAC address.

As a result of the comparison, when the source address of the received packet is matched with the MAC address of the VoIP terminal 2a or 2b existing in the MAC address table 230, the reception controller 260 determines the received packet to be the voice packet, and stores the received voice packet in the real-time service reception queue 224 after removing the 802.11 header from the voice packet.

By the contrast, when the destination address of the received packet is not matched with the MAC address of the VoIP terminal 2a or 2b in the MAC address table 230, the received packet is determined to be the data packet, and the received packet is stored in the data reception queue 212 after the 802.11 header is removed from the data packet.

Further, the reception controller 260 controls the real-time service reception queue 224 so as to process the voice packet in preference, and controls the data reception queue 222 so as to process the data packets within the average delay time of the voice packet.

The WLAN device driver 200 of the AP 1 shown in FIG. 3 provides the fragmentation threshold values of the data packets to the data terminals 2c and 2d connected to the AP so as to prevent a transmission delay of the voice packet resulting from the transmission delay of the data packet in advance, wherein the fragmentation threshold values of the data packets are calculated in the pre-processing controller 240.

In general, the voice packet has a slightly different size according to a payload size, for example a small size of 20 bytes or so. By contrast, the data packet has a relatively large size. Hence, coexistence of the voice packet and the data packet causes the transmission delay of the voice packet resulting from the transmission delay of the data packet.

For this reason, in the present invention, the fragmentation threshold values of the data packets are provided to the data terminals 2c and 2d connected to the AP 1. The data terminals 2c and 2d receiving the fragmentation threshold values transmits the data packet fragmentized in a predetermined size. Thereby, all voice packets can be processed within the average permissible is delay time in the WLAN device driver 200.

Hereinafter, a method of calculating the fragmentation threshold value in the pre-processing controller 240 of the AP 1 will be described in detail.

A systemic environment of the WLAN applicable to the present invention complies with general environmental conditions of the WLAN, and more particularly as follows:

a) Protocol: IEEE (Institute of Electrical and Electronics Engineers) 802.11 WLAN (wireless local area network) standard

b) LAN (local area network) Networking Protocol: CSMA/CA (Carrier Sense Multiple Access with Collision Avoidance) with DCF (Distributed Coordination Function)

c) Backoff Rules: Binary Exponential Backoff rules

d) Transmission Method: DSSS (Direct Sequence Spread Spectrum)

e) Connection Mechanism:

e-1) Basic Mechanism: 2-way handshaking

e-2) RTS/CTS Mechanism: 4-way handshaking

Further, the WLAN device driver of the present invention calculates the average permissible delay time of the voice packet and the fragmentation threshold value based on the average permissible delay times of the voice packet under the following assumptions.

First, the probability of data collision between the packets transmitted from the WLAN service terminals (data terminals and VoIP terminals) is constant and independent.

Second, there is no hidden terminal and all the voice packets have a specific size depending on the kinds of CODECs (coder/decoder).

Third, the WLAN service terminal failing to transmit the packet attempts to retransmit the packet after other WLAN service terminals complete packet transmission.

Further, there are parameters for determining an average permissible delay time of the voice packet at the VoIP terminal according to the present invention as follows:

a) The number of the VoIP terminals connected to the AP: N_{V}

b) The number of the data terminals connected to the AP: N_{D}

c) Time which it takes the VoIP terminal to successfully complete transmission of one voice packet after acquiring a channel: T_{vsucc}

d) Lapse time consumed until the VoIP terminal fails to transmit the voice packet: T_{vcoll}

e) Time which it takes the data terminal to successfully complete transmission of one data packet after acquiring a channel: T_{Dsucc}

f) Lapse time consumed until the data terminal fails to transmit the data packet: T_{Dcoll}

g) Probability of packet transmission by the VoIP terminal or the data terminal: 1−P

h) Probability of packet transmission failure by the VoIP terminal or the data terminal: P

i) Average payload size of data packets: E[D]

j) Average payload size of voice packets: E[VoIP]

k) The maximum number of backoff stages: m

l) Data transmission rate of the AP: λ(Mbps)

With such conditional environments and parameters, the pre-processing controller 240 of the WLAN device driver 200 shown in FIG. 3 calculates the fragmentation threshold value based on the average permissible delay time of the voice packet.

The maximum average permissible delay time X of the voice packet is the maximum transmission delay time permitting a continuous voice call without disconnection as far as a final destination.

Such a maximum average permissible delay time X of the voice packet can be calculated using Equation 1 as follows

X=T_{srcnode}+Tᵤₚₗᵢₙₖ+T_{AP}+T_{downlink}+T_{dstnode}≦150 ms [Equation1]

The maximum average permissible delay time X of the voice packet is calculated with considering the worst case involved in delay factors.

Usually, they encounter with variable voice qualities according to values of the maximum average permissible delay time X; for instance, the X within 150 ms (milliseconds) offers the best voice quality as high as possible, the X within 250 ms is proper to offer a higher voice quality, the X within 350 ms offers a normal voice quality, and the X within 450 ms provides a relatively lower voice quality.

Therefore, the embodiment of the invention is preferably designed to calculate the fragmentation threshold value enabling a voice packet to be transmitted with the maximum average permissible delay time X of 150 ms for the best voice quality.

The term T_{srcnoe} represents a packet transmission delay time at the WLAN service terminals to which a packet is transmitted, and is calculated by Equation 2 as follows.

T_{srcnode}=(coding)+(packetization)+(buffering)+(I/O processing) [Equation2]

At this time, the term T_{srcnode} has a fixed value according to the kinds of coding patterns, and the time values of the packetization, buffering, and the I/O (input/output) processing are previously given by vendors.

The term Tᵤₚₗᵢₙₖ of Equation 1 represents a packet transmission time between the WLAN service terminals (the VoIP terminals and the data terminals) intended to transmit the packet and the AP, being calculated by Equation 3 as follows.

Tᵤₚₗᵢₙₖ=((N_{V}*T_{Vcoll}*P)+(N_{V}*T_{Vsucc}*(1−P)))+((N_{V}*T_{Dcoll}*P)+(N_{V}*T_{Dsucc}*(1−P))) [Equation 3]

The term Tᵤₚₗᵢₙₖ is variable dependent on the systemic environment of the WLAN.

It will be more described about Equation 3 used to calculate Tᵤₚₗᵢₖ. (=Tᵥᵢ).

The T_{AP} of Equation 1 is a packet transmission delaytime at the AP and is calculated using Equation 4 as follows.

T_{AP}=(I/O processing)+(queuing)+(packet processing) [Equation4]

As the lapse times of I/O processing, queuing, and packet processing have values previously provided by vendors, the packet transmission delay time at the AP, T_{AP}, is a fixed value.

In addition, the term T_{downlink} in Equation 1 is a packet transmission delay time between the AP and the WLAN service terminals (the VoIP and data terminals) intended to receive packets, being calculated by the following Equation 5.

T_{downlink}=a packet size to be transmitted/an AP transmission data rate λ (Mbps) [Equation 5]

The term T_{dstnode} of Equation 1 denotes a transmission delay time at the WLAN service terminals (the VoIP and data terminals) intended to receive a packet, which is negligible because it is rated of an extremely short time.

Hereinbelow is described about the former Equation 3, representing Tᵤₚₗᵢₙₖ, namely the packet transmission time between the WLAN service terminals (the VoIP and data terminals) intended to receive the packet and the AP, with reference to Equation 6 as follows.

Tᵤₚₗᵢₙₖ=Tᵥᵢ=((Nᵥ*T_{vcoll}*P)+(Nᵥ*T_{Vsucc}*(1−P)))+((N_{D}*T_{Dcoll}*P)+(N_{D}*T_{Dsucc}*(1−P))) [Equation 6]

The Tᵤₙₗᵢₙₖ, the transmission delay time between the WLAN service terminals and the AP, at this time is identical to the maximum standby time Tᵥᵢ lapsing, by one VoIP terminal (e.g., 2a), from after transmitting a current packet to before transmitting the next packet.

Namely, the Tᵥᵢ is a time of waiting for to transmit the next packet after all the WLAN service terminals 2a to 2d connected to the AP each transmit the packet at least once when one VoIP terminal is about to transmit a new one next to a current packet in a DCF mode.

The parameters determining the maximum standby time Tᵥᵢ (=Tᵤₚₗᵢₙₖ) are defined as follows.

a) N_{V} is the number of the VoIP terminals connected to the AP

b) N_{D} is the number of the data terminals connected to the AP

The term T_{Vcoll} in Equation 1 (and specifically Equations 3 and 6) is a time consumed during a collision of transmitting, due to the data collision, the voice packet by the VoIP terminal, and is calculated using Equation 7 as follows.

a) Basic mode: T_{Vcoll}=(E[VoIP]/λ)+DIFS

b) RTS/CTS mode: T_{Vcoll}=RTS+DIFS [Equation 7]

In Equation 7, E[VoIP] is an average payload size of voice packets, DIFS (Distributed Coordination Function Integer Frame Space) is the longest time interval between delay packets/frames, and RTS is a time lapsing for transferring a signal indicating that the AP is ready to receive data.

The term T_{Vsucc} in Equation 1 (and specifically Equations 3 and 6) represents a time which it takes the VoIP terminal to complete transmission of one voice packet after acquisition of a channel, and is calculated using Equation 8 as follows.

a) Basic mode: T_{Vsucc}=(E[VoIP]/λ)+SIFS+ACK+DIFS

b) RTS/CTS mode: T_{Vsucc}=RTS+3SIFS+CTS+(E[VoIP]/λ)+ACK+DIFS [Equation 8]

The CTS (Clear To Send) is a time for transferring a signal informing all of peripheral terminals connected to a corresponding AP that the WLAN service terminals (the VoIP and data terminals) are prepared to receive data, and the ACK (Acknowledgement) is a time for transferring an ACK packet informing normal reception of a packet. The SIFS (Short Inter Frame Space) is a short standby time for the ACK, the CTS, and a polling operation. It is possible to spend the ACK or the CTS by a terminal prior to a terminal that should wait for the DIFS with the highest priority.

The term T_{Dcoll} in the Equation 1 (and specifically in Equations 3 and 6) is a time consumed until the data terminal fails to transmit the data packet, and is calculated using Equation 9 as follows.

a) Basic mode: T_{Dcoll}=(E[D]/λ)+DIFS

b) RTS/CTS mode: T_{Dcoll}=RTS+DIFS [Equation9]

The [D] is an average payload size of data packets.

The term T_{Dsucc} in Equation 1 (and specifically in Equations 3 and 6) is a time which it takes the data terminal to successfully complete transmission of the data packet after acquisition of a channel, and is calculated using Equation 10 as follows.

c) Basic mode: T_{Dsucc}=(E[D]/λ)+SIFS+ACK+DIFS

d) RTS/CTS mode: T_{Dsucc}=RTS+3DIFS+CTS+(E[D]/λ)+ACK+DIFS [Equation 10]

The term P is the probability of packet transmission failure (or collision) of the VoIP terminal or the data terminal, and defined by Equation 11 as follows.

P=1−(1−τ)ⁿ⁻¹ [Equation 11]

The parameter τ represents the probability of performing packet transmission by the VoIP terminal or the data terminal in a randomly given slot time. The value of n is the number of transmission trials. The probability τ is calculated by the following Equation 12 by means of the bi-dimensional Markov chain model that is utilized to determine behavior of each WLAN service terminal.

$$τ = {\sum }_{i = 0}^{m} {π}_{i , 0} \frac{2 ( 1 - 2 p )}{( 1 - 2 p ) ( W + 1 ) + pW ( 1 - {( 2 p )}^{m} )} \qquad [ Equation 12 ]$$

In Equation 12, the parameter m is the maximum number of backoff stages, the parameter π_{i,0} represents stationary distribution of the WLAN service terminals 2a to 2d, and the parameter W represents the minimum value of contention window.

The following Table 1 arranges exemplary values of parameters determining the payload size E[VoIP] of the voice packet in accordance with the kinds of ITU-T (International Telecommunication Union—Telecommunication Standardization Sector) G.7xx CODECs.

TABLE 1

| | Data Rate | Delay Time | | |
|---|---|---|---|---|
| Class | (kbit/s) | (ms) | MIPS | Band Width |
| G. 711 | 64 | 0 | <<1 | 4 |
| G. 722 | 64/56/48 | 3 | 10 | 7 |
| G. 726 | 32/24/16 | 0.25 | 1.25 | 4 |
| G. 728 | 16 | 1.25 | 30 | 4 |
| G. 729 | 8 | 25 | 20 | 4 |
| G. 723. 1 | 5.3/6.3 | 62.5 | 20 | 4 |

The physical parameters used as described above have their own values fixed in accordance with transmission patterns, as shown in the following Table 2.

TABLE 2

| Parameter | DSSS | FHSS | IR |
|---|---|---|---|
| Slot Time | 20 μs | 50 μs | 8 μs |
| (microsecond) | | | |
| SIFS | 10 μs | 28 μs | 7 μs |
| (microsecond) | | | |
| DIFS | 50 μs | 128 μs | 19 μs |
| (microsecond) | | | |
| ACCA Time | ≦15 μs | 27 μs | 5 μs |
| (microsecond) | | | |
| The Maximum | 2312 bytes | 2312 bytes | 2312 bytes |
| MSDU size | | | |
| (byte) | | | |
| RxTxAr Time | 10 μs | 19 μs | 0 μs |
| (microsecond) | | | |
| Physical Preamble | 192 bits | 122 bits | 92˜112 bits |
| (bit) | | | |

The transmission type according to the 802.11 WLAN standard supports the DSSS (Direct Sequence Spread Spectrum) type and uses the physical parameter values assigned to the DSSS type.

As known from the former description, it is proper to set the calculated maximum average permissible delay time X of the voice packet to less than 150 ms in order to implement an optimum traffic condition. In the equations, the payload size of the voice packet, E[VoIP], is fixed to a constant value in accordance with the kinds of CODECs, while the average payload size of the data packet of the data terminal, E[D], is determined by the values of X, N_{V}, and N_{D}.

In Equation 1, the Tᵤₚₗᵢₙₖ may be derived from Equation 13 as follows.

Tᵤₚₗᵢₙₖ (=Tᵥᵢ)≦150 ms−(T_{srcnode}+T_{AP}+T_{downlink}) [Equation 13]

Substituting Equation 3 into Equation 13, the T_{Dsucc} is derived, from which the E[D] is calculated.

The calculated E[D] becomes a reference for the fragmentation threshold values of all data terminals connected to the AP, and the pre-processing controller 240 transmits the calculated fragmentation threshold values to the data terminals 2c and 2d.

Each data terminal receiving the fragmentation threshold value from the AP applies the received fragmentation threshold value to its own MAC chip, thereby fragmentizing and transmitting the data or packet.

This reduces the transmission time of the data terminal and the time of Tᵥᵢ, offering more chances of transmission to the VoIP terminal within the same time period under the DCF (Distributed Coordination Function) environment. Thus, it may down transmission delays towards a final destination.

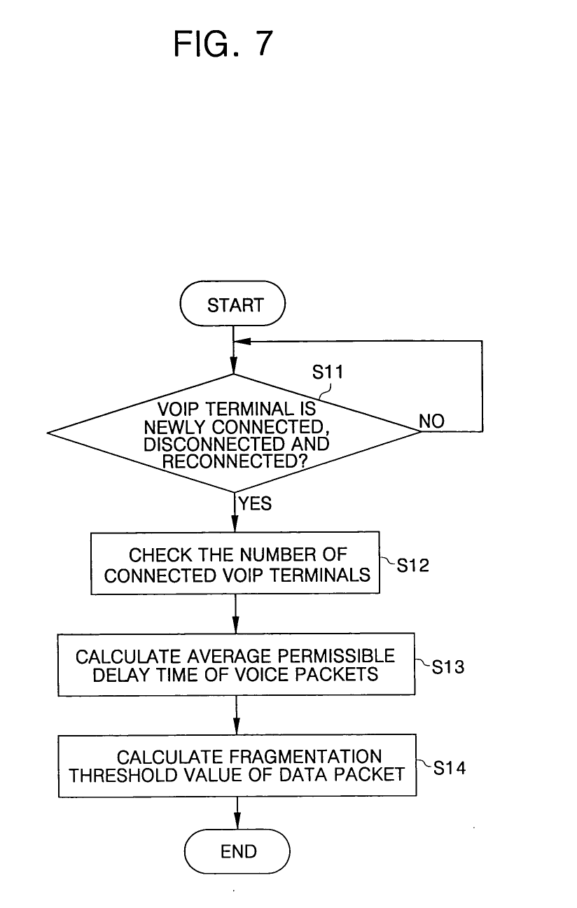

FIG. 7 is an operational flow chart showing a method of calculating the fragmentation threshold value.

As shown in FIG. 7, first, the WLAN device driver of the AP detects whether the WLAN service terminal is connected, disconnected, or reconnected to the AP 1(S 11).

The WLAN device driver checks the number of the VoIP terminals 2a and 2b connected to the AP 1 (S12).

Then, the WLAN device driver calculates the average permissible delay time of the voice packet by using the parameters determining the average permissible delay time of the voice packet (S13).

The fragmentation threshold value of the data packet is calculated so that the data packet can be processed within the calculated average permissible delay time, and then transferred to the data terminals 2c and 2d connected to the AP 1 (S14).

In this manner, the data terminals 2c and 2d connected to the AP 1 receive the fragmentation threshold value from the AP 1, fragmentize the data packet on the basis of the fragmentation threshold value received from the AP 1, and transmit the fragmentized data packets.

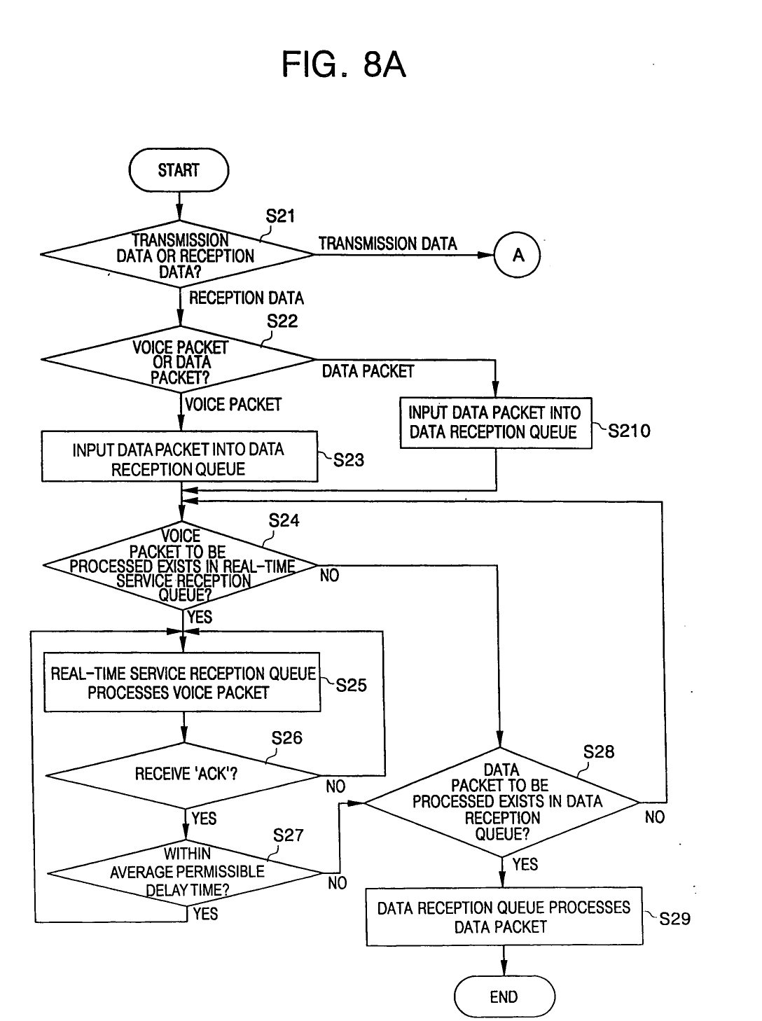

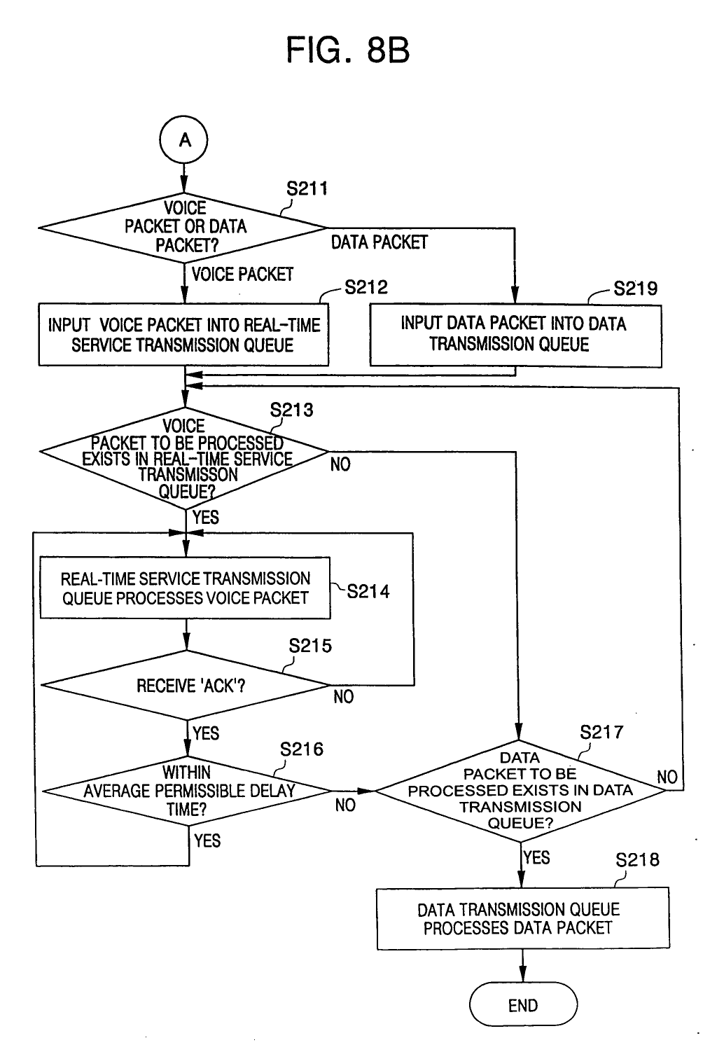

Then, the AP 1 processes both the data packets fragmentized by the data terminals 2c and 2d and the voice packets received from the VoIP terminals 2a and 2b. This processing method will be described below with reference to FIGS. 8A and 8B.

FIGS. 8A and 8B are operational flow charts showing a method of processing transceived voice and data packets in the AP.

First, the AP detects whether reception data or packet and transmission data or packet are coming therein, wherein the reception packet has a packet proceeding direction toward the protocol stack 30, and the transmission packet has that toward the NIC 10 (S21).

If the incoming of the reception data is detected, a source address of the 802.11 packet is extracted to confirm whether the reception data is a voice packet or not. Then, it is determined whether there is the VoIP terminal having an address, which is matched with the extracted source address, in the MAC address table 230 (S22).

As a result of the determination, if there is the VoIP terminal (e.g., 2a) having an address, which is matched with the extracted source address, in the MAC address table 230, the reception data is confirmed to be the voice packet. Then, the 802.11 packet is converted into the 802.3 packet by removing the 802.11 header therefrom and stored in the real-time service reception queue 224 (S23).

The real-time service reception queue 224 checks whether there is a voice packet to be processed within the average permissible delay time (S24).

As a result of the checking, if there is a voice packet to be processed within the average permissible delay time, the voice packet is transmitted to the protocol stack 30 according to the FIFO discipline (S25).

Continuously, the AP checks whether an ACK (Acknowledgement) signal for the transmitted voice packet is received from the protocol stack 30 (S26).

If the ACK signal is received from the protocol stack 30, it is regarded as successful transmission of the voice packet. Then, the AP checks whether another voice packet to be processed within the average permissible delay time before processing the next voice packet exists in-the real-time service reception queue 224 (S27).

As a result of the checking, if no voice packet to be processed exists in the real-time service reception queue 224 or to be processed within the average permissible delay time, the AP checks whether there is a data packet to be processed in the data reception queue 222 (S28).

As a result of the checking, if a data packet to be processed is held in the data reception queue 222, the held data packet is transmitted to the protocol stack 30 according to the FIFO discipline (S29).

Meanwhile, in step S22, if the VoIP terminal 2a or 2b having the address matched with the extracted source address does not exist, the reception data is determined to be the data packet. Then, the 802.11 packet is converted into the 802.3 packet by removing the 802.11 header therefrom and stored in the data reception queue 222 as the data packet (S210). Then, it goes to the step S24 to check whether a voice packet to be processed within the average permissible delay time exists in the real-time service reception queue 224.

In step S21, if the outgoing of the transmission data is detected, a destination address of the 802.3 packet is extracted, and the AP determines whether there is the VoIP terminal 2a or 2b having an address matched with the extracted destination address in the MAC address table 230 (S211).

As a result of the determination, if there is the VoIP terminal 2a or 2b having an address matched with the extracted destination address, the transmission data is regarded as a voice packet and stored in the real-time service packet transmission queue 214 (S212).

Subsequently, the AP checks whether a voice packet to be processed is stored in the real-time service packet transmission queue 214 (S213).

If the voice packet to be processed is stored in the real-time service packet transmission queue 214, the voice packet is transmitted to the NIC 10 according to the FIFO discipline (S214).

Continuously, the AP checks whether an ACK signal for the transmitted voice packet is. received from the NIC 10 (S215).

If the ACK signal is received from the NIC 10, it is regarded as successful transmission of the voice packet. Then, the AP checks whether another voice packet to be processed within the average permissible delay time before processing the next voice packet existing in the real-time service packet transmission queue 214 (S216).

If there is no voice packet, to be processed, in the real-time service transmission queue 214 or to be processed within the average permissible delay time, the AP checks whether a data packet to be processed exists in the data transmission queue 212 (S217).

If the data packet to be processed exists in the data transmission queue 212, the data packet is transmitted to the NIC 10 according to the FIFO discipline after being converted into the 802.11 packet (S218).

Meanwhile, in Step S211, if the VoIP terminal 2a or 2b having the address matched with the extracted destination address does not exist, the transmission packet is determined to be the data packet. Then, the 802.3 packet is stored in the data transmission queue 212 as the data packet (S219). In addition, the AP checks whether a voice packet to be processed within the average permissible delay time exists in the real-time service packet transmission queue 214.

According to a result of the checking, the voice and data packet services are repeatedly. performed by use of the foregoing method.

The present invention can be realized as computer-executable instructions in computer-readable media. The computer-readable media includes all possible kinds of media in which computer-readable data is stored or included or can include any type of data that can be read by a computer or a processing unit. The computer-readable media include for example and not limited to storing media, such as magnetic storing media (e.g., ROMs, floppy disks, hard disk, and the like), optical reading media (e.g., CD-ROMs (compact disc-read-only memory), DVDs (digital versatile discs), re-writable versions of the optical discs, and the like), hybrid magnetic optical disks, organic disks, system memory (read-only memory, random access memory), non-volatile memory such as flash memory or any other volatile or non-volatile memory, other semiconductor media, electronic media, electromagnetic media, infrared, and other communication media such as carrier waves (e.g., transmission via the Internet or another computer). Communication media generally embodies computer-readable instructions, data structures, program modules or other data in a modulated signal such as the carrier waves or other transportable mechanism including any information delivery media. Computer-readable media such as communication media may include wireless media such as radio frequency, infrared microwaves, and wired media such as a wired network. Also, the computer-readable media can store and execute computer-readable codes that are distributed in computers connected via a network. The computer readable medium also includes cooperating or interconnected computer readable media that are in the processing system or are distributed among multiple processing systems that may be local or remote to the processing system. The present invention can include the computer-readable medium having stored thereon a data structure including a plurality of fields containing data representing the techniques of the present invention.

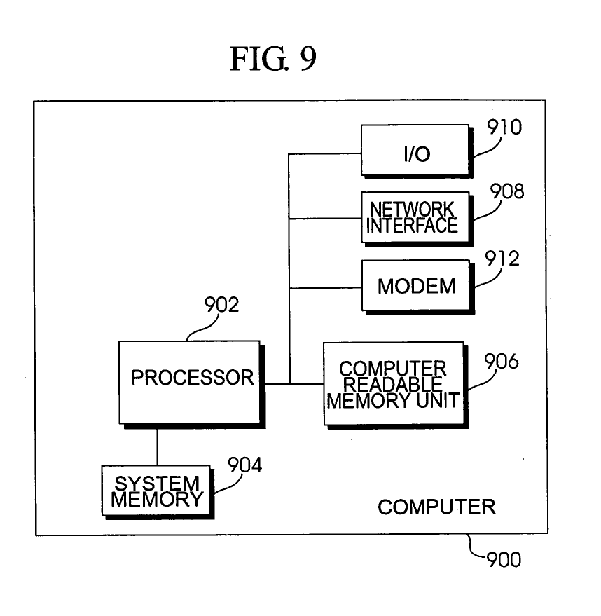

An example of a computer, but not limited to this example of the computer, that can read computer readable media that includes computer-executable instructions of the present invention is shown in FIG. 9. The computer 900 includes a processor 902 that controls the computer 900. The processor 902 uses the system memory 904 and a computer readable memory device 906 that includes certain computer readable recording media. A system bus connects the processor 902 to a network interface 908, modem 912 or other interface that accommodates a connection to another computer or network such as the Internet. The system bus may also include an input and output interface 910 that accommodates connection to a variety of other devices.

Although the apparatus and method for processing packets according to the invention has been described taking the WLAN AP as one example, but it will be understood to those skilled in the art that the apparatus and method for processing packets of the present invention may be applied to all the apparatuses and methods used to process packets. For this reason, the right protection scope of the present invention should be defined by the following claims.

As set forth above, in the case that real-time services and data services based on FTP (File Transfer Protocol) used to transceive a great volume of data are provided within one BSS (Basic Service Set) area, the real-time services transmitting and receiving packets by periods is considerably influenced by the data services, and thus there is nothing for it but to frequently experience disconnection or delay phenomenon of voice or moving image. However, the apparatus and method for processing packets in the WLAN AP makes use of a double queue, manages MAC addresses of real-time service terminals through a link list, and assigns a priority to real-time service packets. Hence, when packet service is provided, the real-time service packets are first processed, and after the real-time service packets are completely processed, data packets are processed. Thereby, it is possible to guarantee the QoS of voice or moving image packets.

In addition, when the real-time service packets are only the voice packets, a fragmentation threshold value is provided to the data terminals from which the data packets are transmitted. In order to process the data packets, the maximum permissible delay time of the voice packets is calculated, and then each data packet is inserted between the voice packets. Thereby, throughput for traffic of each data terminal can be enhanced.

What is claimed is:

1. An apparatus for processing packets comprising:
a reception queue, including a first reception queue processing at least one real-time service packet and a second reception queue processing at least one data packet, for processing at least one of said real-time service and data packets received from at least one service terminal and for transmitting the processed packet to an Internet protocol network, said real-time service packet accommodating image and voice packet;
a transmission queue, including a first transmission queue processing at least one real-time service packet and a second transmission queue processing at least one data packet, for processing at least one of said real-time service and data packets received from said Internet protocol network and for transmitting the processed packet to the at least one service terminal; and
a packet processor for controlling transmission of said real-time service and data packets stored in said reception and transmission queues to any one of the Internet protocol network and the service terminal in accordance with a preset priority.

2. The apparatus of claim 1, wherein said service terminal includes at least one of:
at least one real-time service terminal for processing said real-time service packet to provide real-time voice and image services; and
at least one data terminal for processing the data packet to provide data communication service.

3. The apparatus of claim 1, further comprising:
a pre-processing controller for setting a priority to process at least one of transmitted/received packets according to kinds of the transmitted/received packets; and
a storage unit for storing information on the priority to compare and analyze kinds of the transmitted/received packets.

4. The apparatus of claim 3, wherein the priority information includes information on a medium access control address of said real-time service terminal.

5. The apparatus of claim 4, wherein the packet processor compares the medium access control addresses of the real-time service terminals stored in said storage unit with a source address of any one of transmitted and received packets to confirm whether to be matched with the source address, determines any one of the transmitted and received packets to be the real-time service packet when the matched medium access control address exists in said storage unit, and stores the result in any one of the first transmission and reception queues, and determines any one of the transmitted and received packets to be the data packet when the matched medium access control address does not exist in said storage unit and stores the result in any one of the second transmission and reception queues.

6. The apparatus of claim 5, wherein said packet processor includes:
a reception controller for preferentially processing the real-time service packet stored in said first reception queue, transmitting the processed packet to the Internet protocol network, and when the real-time service packets are all transmitted, transmitting the data packet stored in the second reception queue to the Internet protocol network; and
a transmission controller for preferentially processing the real-time service packet stored in said first transmission queue to transmit the packet to a real time service terminal, transmitting the processed packet to the Internet protocol network, and when the real-time service packets are all transmitted, transmitting the data packet stored in said second transmission queue to the service terminal.

7. The apparatus of claim 6, wherein said reception controller is holding transmission of the data packet when at least one new real-time service packet is coming in said first reception queue while the data packet stored in said second reception queue is processed and transmitted to the Internet protocol network, and after the new real-time service packets coming in said first reception queue are all transmitted to the Internet protocol network, transmitting the held data packet to the Internet protocol network.

8. The apparatus of claim 6, wherein said transmission controller is holding transmission of the data packet when at least one new real-time service packet is coming in said first transmission queue while the data packet stored in said second transmission queue is processed and transmitted to a data terminal of said service terminals, and after the new real-time service packets coming in said first transmission queue are all transmitted to the service terminals, transmitting the held data packet to a real-time service terminal of the service terminals.

9. The apparatus of claim 3, wherein when the real-time service packet is a voice packet, a fragmentation threshold value is calculated using an average permissible transmission delay time of the voice packet and the number of voice over Internet protocol and data terminals of the service terminals connected to a system and provides the result to the data terminal.

10. The apparatus of claim 6, wherein said packet processor:
controls the reception queue such that, when a voice packet is received from a voice over Internet protocol terminal of the service terminals, the received voice packet is preferentially processed and that the data packet transmitted from a data terminal of said service terminals is processed within an average permissible transmission delay time of the voice packet; and
processes the voice packet to be transmitted to the voice over Internet protocol terminal in preference and then the data packet to be transmitted to the data terminal within the average. permissible transmission delay time of the voice packet.

11. The apparatus of claim 9, wherein the average permissible transmission delay time of the voice packet in said pre-processing controller is calculated using at least one of:
the number of the voice over Internet protocol terminals connected to the system,
the number of the data terminals connected to the system,
a first time which it takes the voice over Internet protocol terminal to successfully complete transmission of one voice packet after acquisition of a channel,
a first lapse time consumed until the voice over Internet protocol terminal fails to transmit the voice packet,
a second time which it takes the data terminal to successfully complete transmission of one data packet after acquisition of a channel,
a second lapse time consumed until the data terminal fails to transmit the data packet,
a first probability of packet transmission by any one of the voice over Internet protocol terminal and the data terminal,
a second probability of packet transmission failure by any one of the voice over Internet protocol terminal and the data terminal,
a first average payload size of data packets,
a second average payload size of voice packets,
the maximum number of backoff stages, and
a data transmission rate of the system.

12. A method for processing packets comprising:
when any one of at least one real-time service packet and at least one data packet is received from an Internet protocol network, storing the received packets in different transmission queues respectively based on kinds of the received packets, the real-time service packet accommodating image and voice packet; and
processing the real-time service packets stored in said transmission queues in preference, transmitting the processed real-time service packets to at least one real-time service terminal, processing the data packets stored in said transmission queues after transmission of the real-time service packets is completed, and transmitting the processed data packets to at least one data terminal.

13. The method of claim 12, wherein the step of storing the received packets in different transmission queues includes comparing previously stored medium access control addresses of said real-time service terminals with a source address of a packet received from the Internet protocol network to confirm whether to be matched with the source address, determining the received packet to be the real-time service packet when the matched medium access control address is present, and storing the result in a real-time service packet transmission queue of said transmission queues, determining the received packet to be the data packet when the matched medium access control address is not present, and storing the result in a data transmission queue of said transmission queues.

14. The method of claim 12, wherein the step of processing the real-time service packets and transmitting the real-time service and data packets stored in said transmission queues includes holding transmission of the data packet when at least one new real-time service packet is coming in a real-time service packet transmission queue of said transmission queues while the data packet stored in a data transmission queue of said transmission queues is processed and transmitted to said data terminal, and after the new real-time service packets coming in said real-time service packet transmission queue are all transmitted to said real-time service terminal, transmitting the held data packet to said data terminal.

15. The method of claim 12, further comprising:
when any one of the real-time service packet and the data packet is received from any one of said real-time service terminal and the data terminal, storing the received packets in different reception queues respectively based on kinds of the received packets, the real-time service packet accommodating image and voice packet; and
processing the real-time service packets stored in said reception queues in preference, transmitting the processed real-time service packets to the Internet protocol network, processing the data packets stored in said reception queues after transmission of the real-time service packets is completed, and transmitting the processed data packets to the Internet protocol network.

16. The method of claim 15, wherein the step of storing the received packets in different reception queues respectively based on kinds of the received packets includes comparing previously stored medium access control addresses of said real-time service terminals with a source address of a packet received from any one of said real-time service terminal and said data terminal to confirm whether to be matched with the source address, determining the received packet to be the real-time service packet when the matched medium access control address is present, and storing the result in a real-time service packet reception queue of the reception queues, determining the received packet to be the data packet when the matched medium access control address is not present, and storing the result in a data reception queue of the reception queues.

17. The method of claim 15, wherein said step of processing the real-time service and data packets stored in said reception queues, and transmitting the processed real-time service packets and data packets to the Internet protocol network, includes holding transmission of the data packet when at least one new real-time service packet is coming in a real-time service packet reception queue of the reception queues while the data packet stored in a data reception queue of the reception queues is processed and transmitted to the Internet protocol network, and after the new real-time service packets coming in the real-time service packet reception queue are all transmitted to the Internet protocol network, transmitting the held data packet to the Internet protocol network.

18. An apparatus for processing packets comprising:
a reception queue for sequentially storing any one of at least one real-time service packet and at least one data packet which are received from at least one service terminal;
a transmission queue for storing at least one real-time service packet and at least one data packet which are received from an Internet protocol network in different queues respectively; and
a transmission/reception controller for controlling transmission of the real-time service and data packets stored in said transmission queue to the Internet protocol network in accordance with a preset priority and transmission of the packets stored in said reception queue through a sequential processing operation.

19. The apparatus of claim 18, further comprising:
a pre-processing controller for setting a priority to process the packets according to kinds of the packets received from the Internet protocol network; and
a storage unit for storing information on the priority to compare and analyze the kinds of packets received from the Internet protocol network.

20. The apparatus of claim 19, wherein the priority information includes information on a medium access control address of the real-time service terminal.

21. The apparatus of claim 18, wherein the transmission/reception controller compares the medium access control addresses of the real-time service terminals stored in said storage unit with a source address of at least one packet received from the Internet protocol network to confirm whether to be matched with the source address, determines the received packet to be the real-time service packet when the matched medium access control address exists in said storage unit, and stores the result in a real-time service packet transmission queue of said transmission queue, and determines the received packet to be the data packet when the matched medium access control address does not exist in the storage unit and stores the result in a data transmission queue of said transmission queue.

22. The apparatus of claim 18, wherein the transmission/reception controller includes:
a transmission controller for sequentially processing any one of the real-time service and data packets stored in said reception queue according to a first in first out discipline and for transmitting the processed result to the Internet protocol network; and
a reception controller for preferentially processing the real-time service packet stored in a real-time service packet transmission queue of said transmission queue, transmitting the processed result to a real-time service terminal of the service terminals, and when the real-time service packets are all transmitted, transmitting the data packet stored in a data transmission queue of the transmission queue to a data terminal of the service terminal.

23. The apparatus of claim 22, wherein said transmission controller is holding transmission of the data packet when at least one new real-time service packet is coming in said real-time service packet transmission queue while the data packet stored in the data transmission queue is processed and transmitted to the data terminal, and after the new real-time service packets coming in the real-time service packet transmission queue are all transmitted to the real-time service terminal, transmitting the held data packet to the data terminal.

24. A method for processing packets comprising:
when any one of at least one real-time service packet and at least one data packet is received from an Internet protocol network, storing the received packets in a real-time service packet transmission queue and a data transmission queue respectively based on the kinds of received packets, and sequentially storing any one of at least one real-time service packet and at least one data packet which are received from at least one service terminal in a reception queue, real-time service packet accommodating image and voice packet; and
processing the real-time service packets stored in said real-time service packet transmission queue in preference, transmitting the processed real-time service packets to at least one real-time service terminal, processing the data packets stored in said data transmission queue after transmission of the real-time service packets is completed, and transmitting the processed data packets to at least one data terminal,
sequentially transmitting at least one of the real-time service packets and the data packets which are sequentially stored in said reception queue to the Internet protocol network.

25. The method of claim 24, wherein the step of storing the received packets in said real-time service packet transmission queue and said data transmission queue and sequentially storing any one of at least one real-time service packet and at least one data packet in a reception queue, includes comparing previously stored medium access control addresses of said real-time service terminals with a source address of a packet received from the Internet protocol network to confirm whether to be matched with the source address, determining the received packet to be the real-time service packet when the matched medium access control address is present, and storing the received packet in said real-time service packet transmission queue, determining the received packet to be the data packet when the matched medium access control address is not present, and storing the received packet in said data transmission queue.

26. The method of claim 24, wherein the step of processing the real-time service packets stored in said real-time service packet transmission queue in preference, transmitting the processed real-time service packets to at least one real-time service terminal, processing the data packets stored in said data transmission queue after transmission of the real-time service packets is completed, and transmitting the processed data packets to at least one data terminal, includes holding transmission of the data packet when at least one new real-time service packet is coming in said real-time service packet transmission queue while the data packet stored in said data transmission queue is processed and transmitted to said data terminal, and after the new real-time service packets coming in the real-time service packet transmission queue are all transmitted to the real-time service terminal, transmitting the held data packet to said data terminal.

27. An apparatus for processing packets, comprising:
a pre-processing controller for calculating a fragmentation threshold value and for providing the calculated fragmentation threshold value to at least one service terminal;
a reception queue, including a voice reception queue processing at least one voice packet and a data reception queue processing at least one data packet, for processing at least one packet received from said service terminal and for transmitting the processed packet to an Internet protocol network;
a transmission queue, including a voice transmission queue processing at least one voice packet and a data transmission queue processing at least one data packet, for processing at least one packet received from the Internet protocol network and for transmitting the processed packet to said service terminal; and
a transmission/reception controller for controlling transmission of the real-time service and data packets stored in the reception and transmission queues to any one of the Internet protocol network and the service terminal in accordance with a preset priority.

28. The apparatus of claim 27, wherein said service terminal includes at least one of:
at least one voice over Internet protocol terminal for processing the voice packet to provide voice service; and
at least one data terminal for processing the data packet to provide data communication service.

29. The apparatus of claim 27, wherein the transmission/reception controller includes:
a reception controller for controlling the reception queue so that the voice packet transmitted from a voice over Internet protocol terminal of said service terminals is preferentially processed and that the data packet transmitted from a data terminal of the service terminals within an average permissible transmission delay time of the voice packet; and
a transmission controller for controlling the transmission queue accommodating the voice packet to be transmitted to the voice over Internet protocol terminal is preferentially processed and the data packet to be transmitted to the data terminal is within the average permissible transmission delay time of the voice packet.

30. The apparatus of claim 27, wherein the pre-processing controller calculates the fragmentation threshold value using the average permissible transmission delay time of the voice packet and the number of voice over Internet protocol and data terminals of the service terminals when the number of the voice over Internet protocol terminals is changed.

31. The apparatus of claim 30, wherein the average permissible transmission delay time of the voice packet is calculated using at least one of:
the number of the voice over Internet protocol terminals connected to the system,
the number of the data terminals connected to the system,
a first time which it takes the voice over Internet protocol terminal to successfully complete transmission of one voice packet after acquisition of a channel,
a first lapse time consumed until the voice over Internet protocol terminal fails to transmit the voice packet,
a second time which it takes the data terminal to successfully complete transmission of one data packet after acquisition of a channel,
a second lapse time consumed until the data terminal fails to transmit the data packet,
a first probability of packet transmission by any one of the voice over Internet protocol terminal and the data terminal,
a second probability of packet transmission failure by any one of the voice over Internet protocol terminal and the data terminal,
a first average payload size of data packets,
a second average payload size of voice packets,
the maximum number of backoff stages, and
a data transmission rate of the system.

32. A method for processing packets comprising:
when the number of voice over Internet protocol terminals is changed, calculating a fragmentation threshold value and transmitting the calculated fragmentation threshold value to at least one data terminal connected to a system;
when any one of at least one voice packet and at least one data packet is received from any one of said voice over Internet protocol terminal and said data terminal, storing the received packet in a corresponding queue according to a kind of the received packet; and
processing the voice packet stored in the queue in preference, transmitting the processed voice packet to the Internet protocol network, processing the data packet within an average permissible transmission delay time (X), and transmitting the processed data packet to the Internet protocol network.

33. The method of claim 32, wherein the step of storing the received packet in said corresponding queue according to a kind of the received packet, includes storing the voice packet in a voice reception queue of the queue when the received packet is the voice packet, and storing the data packet in a data reception queue of the queue when the received packet is the data packet.

34. The method of claim 32, wherein the step of calculating the fragmentation threshold value and transmitting the calculated fragmentation threshold value to at least one data terminal connected to said system, includes:
detecting whether the number of the voice over Internet protocol terminals connected to the system is changed or not;
calculating the average permissible transmission delay time (X) when the number of the voice over Internet protocol terminals is changed; and
calculating the fragmentation threshold value using the calculated average permissible transmission delay time and the number of voice over Internet protocol and data terminals connected to the system and transmitting the calculated fragmentation threshold value to the data terminal.

35. The method of claim 34, wherein the average permissible transmission delay time of the voice packet is calculated using at least one of:
the number of the voice over Internet protocol terminals connected to the system,
the number of the data terminals connected to the system,
a first time which it takes the voice over Internet protocol terminal to successfully complete transmission of one voice packet after acquisition of a channel,
a first lapse time consumed until the voice over Internet protocol terminal fails to transmit the voice packet,
a second time which it takes the data terminal to successfully complete transmission of one data packet after acquisition of a channel,
a second lapse time consumed until the data terminal fails to transmit the data packet,
a first probability of packet transmission by any one of the voice over Internet protocol terminal and the data terminal,
a second probability of packet transmission failure by any one of the voice over Internet protocol terminal and the data terminal,
a first an average payload size of data packets,
a second average payload size of voice packets,
the maximum number of backoff stages, and
a data transmission rate of the system.

36. The method of claim 32, wherein the step of processing the voice packet stored in the queue in preference, transmitting the processed voice packet to the Internet protocol network, processing the data packet within an average permissible transmission delay time (X), and transmitting the processed data packet to the Internet protocol network, further comprises:
checking whether the voice packet exists in a corresponding reception queue within the average permissible transmission delay time; and
as a result of the checking, when the voice packet exists in the corresponding reception queue within the average permissible transmission delay time, processing the data packet and transmitting the processed data packet to the Internet protocol network.

37. The method of claim 32, further comprising:
when the data packets or the voice packets are received from the Internet protocol network, storing the received packets in different transmission queues respectively based on the kinds of received packets; and
processing the voice packets stored in said transmission queues in preference, transmitting the processed voice packets to said voice over Internet protocol terminals, processing the data packets within the average permissible transmission delay time, and transmitting the processed data packets to said data terminals.

38. The method of claim 37, wherein the step of processing the voice packets stored in said transmission queues in preference, transmitting the processed voice packets to said voice over Internet protocol terminals, processing the data packets within the average permissible transmission delay time, and transmitting the processed data packets to said data terminals, further comprises:
checking whether the voice packet to be processed within the average permissible transmission delay time exists in said transmission queue; and
as a result of the checking, when the voice packet to be processed within the average permissible transmission delay time does not exist, processing the data packets and transmitting the processed data packets to said data terminals.

39. The method of claim 32, wherein the average permissible transmission delay time (X) of the voice packet is determined by the following:
X=T_{srcnode}+Tᵤₚₗᵢₙₖ+T_{AP}+T_{downlink}+T_{dstnode}≦150 milliseconds,
where T_{srcnode} represents a packet transmission delay time at the service terminals intended to transmit the packets, Tᵤₚₗᵢₙₖ represents a packet transmission delay time between the service terminals of the voice over Internet protocol terminal and data terminal, intended to transmit the packets and the system, T_{AP} represents a packet transmission delay time at the system, T_{downlink} represents a packet transmission delay time between the service terminals of the voice over Internet protocol terminal and data terminal, intended to receive the packets and the system, T_{dstnode} represents a transmission delay time at the service terminals receiving the packets.

40. The method of claim 39, wherein the T_{srcnode} is determined by the following:
T_{srcnode}=(coding)+(packetization)+(buffering)+(I/O processing),
where T_{srcnode} has a fixed value allocated according to the kinds of coding patterns, and the time values of the packetization, buffering, and the input and output processing are previously given by vendors.

41. The method of claim 39, wherein the Tᵤₚₗᵢₙₖ is determined by the following:
Tᵤₚₗᵢₙₖ=((N_{V}*T_{Vcoll}*P)+(N_{V}*T_{Vsucc}*(1−P)))+((N_{V}*T_{Dcoll}*P)+(N_{V}*T_{Dsucc}*(1−P))),
where N_{V} is the number of the voice over Internet protocol terminals connected to the system, N_{D} is the number of the data terminals connected to the apparatus, T_{Vcoll} is a time consumed until the voice over Internet protocol terminal fails to transmit the voice packet, T_{Vsucc} represents a time which it takes the voice over Internet protocol terminal to completely transmit one voice packet after acquisition of a channel, T_{Dcoll} is a time consumed until the data terminal fails to transmit the data packet, T_{Dsucc} is a time which it takes the data terminal to completely to transmit the data packet after acquisition of a channel, and P is the probability of packet transmission failure or collision of any one of the voice over Internet protocol terminal and the data terminal.

42. The method of claim 41, wherein the Tᵤₚₗᵢₙₖ, the transmission delay time between the voice over Internet protocol and data terminals and the system, at a certain time being identical to the maximum standby time Tᵥᵢ lapsing, by one voice over Internet protocol terminal, from after transmitting a current packet to before transmitting the next packet, where the Tᵥᵢ is a time of waiting for to transmit the next packet after all service terminals connected to the system each transmit packets at least once when one voice over Internet protocol terminal is about to transmit a new one next to a current packet in a distributed coordination function (DCF) mode.

43. The method of claim 39, wherein the T_{AP} is determined by the following:
T_{AP}=(I/O processing)+(queuing)+(packet processing)
where T_{AP} is a fixed value because the time values of the input and output processing, queuing and packet processing are previously given by vendors.

44. The method of claim 41, wherein the T_{Vcoll} is determined by the following:
Basic mode: T_{Vcoll}=(E[VoIP]/λ)+DIFS,
RTS/CTS mode: T_{Vcoll}=RTS+DIFS,
where E[VoIP] is an average payload size of voice packets, DIFS stands for distributed coordination function integer frame space and is the longest time interval between delay packets/frames, RTS stands for ready to send is a time lapsing for transferring a signal indicating that the system is prepared to receive data, λ is the transmission rate of the system, and the CTS represents clear to send and is a time for transferring a signal informing all of peripheral terminals connected to a corresponding system that the service terminals of the voice over Internet protocol terminal and data terminal, are prepared to receive data.

45. The method of claim 41, wherein the T_{Vsucc} is determined by the following:
Basic mode: T_{V}_{succ}=(E[VoIP]/λ)+SIFS+ACK+DIFS,
RTS/CTS mode: T_{Vsucc}=RTS+3SIFS+CTS+(E[VoIP]/λ)+ACK+DIFS,
where CTS represents clear to send and is a time for transferring a signal informing all of peripheral terminals connected to a corresponding system that the service terminals of the voice over Internet protocol terminal and data terminal, are prepared to receive data, and the ACK represents acknowledgement and is a time for transferring an ACK packet informing a normal reception of a packet, and SIFS represents short inter frame space, is a short standby time used for the ACK, the CTS, and a polling operation, and is capable of spending the ACK or the CTS by a terminal prior to a terminal that should wait for the DIFS with the highest priority.

46. The method of claim 41, wherein the T_{Dcoll} is determined as follows:
Basic mode: T_{Dcoll}=(E[D]/λ)+DIFS,
RTS/CTS mode: T_{Dcoll}=RTS+DIFS,
where E[D] is an average payload size of data packets, DIFS represents distributed coordination function integer frame space and is the longest time interval between delay packets/frames, RTS represents ready to send and is a time lapsing for transferring a signal indicating that the system is prepared to receive data, λ is the transmission rate of the system, CTS represents clear to send and is a time for transferring a signal informing all of peripheral terminals connected to a corresponding system that the service terminals of the voice over Internet protocol terminal and data terminal, are prepared to receive data.

47. The method of claim 41, wherein the T_{Dsucc} is determined as follows:
Basic mode: T_{Dsucc}=(E([D]/λ)+SIFS+ACK+DIFS,
RTS/CTS mode: T_{Dsucc}=RTS+3DIFS+CTS+(E[D]/λ)+ACK+DIFS,
where E[D] is an average payload size of data packets, DIFS represents the distributed coordination function integer frame space and is the longest time interval between delay packets/frames, RTS represents ready to send and is a time lapsing for transferring a signal indicating that the system is prepared to receive data, λ is the transmission rate of the system, CTS represents clear to send and is a time for transferring a signal informing all of peripheral terminals connected to a corresponding system that the service terminals of the voice over Internet protocol terminal and data terminal, are prepared to receive data, SIFS represents short inter frame space and is a short standby time used for the ACK, the CTS, and a polling operation, and ACK is a time for transferring an ACK packet informing a normal reception of a packet.

48. The method of claim 41, wherein the P is determined as follows:
P=1−(1−τ)ⁿ⁻¹,
where the parameter τ represents the probability of performing packet transmission by the voice over Internet protocol terminal or the data terminal in a randomly given slot time, the value of n is the number of packet transmission trials.

49. The method of claim 48, with the probability τ is calculated by the following:
$$τ = {\sum }_{i = 0}^{m} {π}_{i , 0} \frac{2 ( 1 - 2 p )}{( 1 - 2 p ) ( W + 1 ) + pW ( 1 - {( 2 p )}^{m} )}$$
where the parameter m is the maximum number of backoff stages, the parameter π_{i,k} represents stationary distribution of the service terminals, and the parameter W represents the minimum value of contention window.

50. A computer-readable medium having computer-executable instructions for performing a method, comprising:
when any one of at least one real-time service packet and at least one data packet is received from an Internet protocol network, storing the received packets in different transmission queues respectively based on kinds of the received packets, the real-time service packet accommodating image and voice packet; and
processing the real-time service packets stored in said transmission queues in preference, transmitting the processed real-time service packets to at least one real-time service terminal, processing the data packets stored in said transmission queues after transmission of the real-time service packets is completed, and transmitting the processed data packets to at least one data terminal.

51. A computer-readable medium having stored thereon a data structure comprising:
a first field containing data representing, when the number of voice over Internet protocol terminals is changed, calculating a fragmentation threshold value and transmitting the calculated fragmentation threshold value to at least one data terminal connected to a system;
a second field containing data representing, when any one of at least one voice packet and at least one data packet is received from any one of said voice over Internet protocol terminal and said data terminal, storing the received packet in a corresponding queue according to a kind of the received packet; and
a third field containing data representing processing the voice packet stored in the queue in preference, transmitting the processed voice packet to the Internet protocol network, processing the data packet within an average permissible transmission delay time, and transmitting the processed data packet to the Internet protocol network.
